(19) United States
(12) Patent Application Publication
(10) Pub. No.: US 2012/0236465 A1
(43) Pub. Date: Sep. 20, 2012

(54) METHOD OF MANUFACTURING ELECTROLYTIC CAPACITOR AND ELECTROLYTIC CAPACITOR

(75) Inventor: Masashi Kondo, Sasebo-shi (JP)

(73) Assignees: SAGA SANYO INDUSTRIES CO., LTD., Kishima-gun (JP); SANYO ELECTRIC CO., LTD., Osaka (JP)

(21) Appl. No.: 13/417,415

(22) Filed: Mar. 12, 2012

(30) Foreign Application Priority Data
Mar. 14, 2011 (JP) 2011-055530

(51) Int. Cl. H01G 9/048; H01G 9/00

(52) U.S. Cl. 361/500; 29/25.03

(57) ABSTRACT

As a core for winding up an anode foil, a cathode foil, and the like, such a core as exhibiting an outer shape having a long-side direction and a short-side direction in a cross-section perpendicular to a rotation central axis, with a straight line in the long-side direction passing through the rotation central axis being defined as a first centerline and with a straight line in the short-side direction passing through the rotation central axis being defined as a second centerline, the outer shape being in asymmetry in a manner at least any of first asymmetry which is asymmetry with respect to the second centerline in the long-side direction and second asymmetry which is asymmetry with respect to the first centerline in the short-side direction, is employed.

This nonprovisional application is based on Japanese Patent Application No. 2011-055530 filed with the Japan Patent Office on Mar. 14, 2011, the entire contents of which are hereby incorporated by reference.

### BACKGROUND OF THE INVENTION

1. Field of the Invention

The present invention relates to a method of manufacturing an electrolytic capacitor and an electrolytic capacitor, and particularly to a method of manufacturing a wound-type electrolytic capacitor formed by winding an anode foil, a cathode foil, and the like and such an electrolytic capacitor.

2. Description of the Related Art

An electrolytic capacitor formed by winding up an anode foil and a cathode foil with separator paper being interposed represents one form of an electrolytic capacitor. An electrolytic capacitor of this type is formed as follows. Initially, an anode lead tab terminal is connected at a prescribed position in a long-side direction of an anode foil, and a cathode lead tab terminal is connected at a prescribed position in a long-side direction of a cathode foil. Then, one-end sides of the anode foil, the cathode foil, and the like are sandwiched in a prescribed core, and the core is turned in a prescribed orientation in that state. Thus, the anode foil, the cathode foil, and the like are wound up from the one-end sides, to thereby form a wound-type electrolytic capacitor.

An electrolytic capacitor has an inductance component referred to as equivalent series inductance (ESL). This ESL increases with the increase in a frequency, and then the electrolytic capacitor cannot function as a capacitor. Therefore, an electrolytic capacitor used in a high-frequency region is required to have lower ESL. In addition, an electrolytic capacitor has a resistance component referred to as equivalent series resistance (ESR), and it is required to have lower ESR.

In order to lower ESR and ESL, for example, a multi-terminal electrolytic capacitor including two anode lead tab terminals and two cathode lead tab terminals has been proposed. Japanese Patent Laying-Open No. 2004-179621 is an exemplary document disclosing such an electrolytic capacitor having a multi-terminal structure.

The inventors, however, have found that a conventional electrolytic capacitor having a multi-terminal structure suffers the following problems.

As described above, an electrolytic capacitor used in a high-frequency region in particular is required to have lower ESL. Since this ESL depends on a pitch between leads of anode (cathode) lead tab terminals, in order to lower ESL, the anode (cathode) lead tab terminals should be arranged in good balance, with regular pitches between four leads being set.

Namely, when an electrolytic capacitor is viewed from the anode (cathode) lead tab terminal side, it is required that respective leads of a first anode lead tab terminal, a second anode lead tab terminal, a first cathode lead tab terminal, and a second cathode lead tab terminal are arranged at positions corresponding to respective vertices of a square (or a rectangle).

As described above, in a wound-type electrolytic capacitor, the anode foil, the cathode foil, and the like are wound up from the one-end sides thereof. Therefore, in second winding and later, the anode foil and the like are further wound up over a portion of the anode foil and the like wound up so far. Then, a distance between the anode foil and the like and a rotation axis center (a distance in a radial direction) becomes greater in a later stage of winding-up. Accordingly, in a capacitor element formed by winding up the anode foil, the cathode foil, and the like, two anode lead tab terminals and two cathode lead tab terminals are displaced from the positions corresponding to the respective vertices of the square.

If positions of the anode (cathode) lead tab terminals are displaced from the positions of the respective vertices of the square, it becomes difficult to insert a lead of each anode (cathode) lead tab terminal into an opening in a sealing rubber gasket, which leads to a bent lead of an anode (cathode) lead tab terminal or collapse of a lead. Even though each anode (cathode) lead tab terminal could be inserted into an opening in the sealing rubber gasket, each anode (cathode) lead tab terminal is not inserted at a prescribed position with respect to the sealing rubber gasket, which leads to a bent lead or collapse of a lead in a subsequent step and hence resultant defective sealing.

Further, if positions of leads of anode (cathode) lead tab terminals are displaced from positions of respective vertices of a square, pitches between the anode (cathode) lead tab terminals vary, ESL increases, and characteristics as the electrolytic capacitor become poorer.

### SUMMARY OF THE INVENTION

A method of manufacturing an electrolytic capacitor according to the present invention is a method of manufacturing an electrolytic capacitor of a wound type, and the method includes the following steps. An anode foil and a cathode foil are prepared. A prescribed core for winding up the anode foil and the cathode foil is prepared. A first anode lead tab terminal, a second anode lead tab terminal, a first cathode lead tab terminal, and a second cathode lead tab terminal are prepared. The first anode lead tab terminal and the second anode lead tab terminal are connected at respective prescribed positions in the anode foil. The first cathode lead tab terminal and the second cathode lead tab terminal are connected at respective prescribed positions in the cathode foil. A capacitor element is formed by sandwiching respective one-end sides of the anode foil and the cathode foil in the core, turning the core around a rotation central axis thereof, and winding up the anode foil and the cathode foil from the respective one-end sides, with the first anode lead tab terminal, the second anode lead tab terminal, the first cathode lead tab terminal, and the second cathode lead tab terminal being arranged in any of prescribed first arrangement and second arrangement with respect to the core. A sealing member is attached to the capacitor element. The capacitor element to which the sealing member has been attached is accommodated in a prescribed container and the capacitor element is sealed.

In the step of preparing a core, such a core as exhibiting an outer shape having a long-side direction and a short-side direction in a cross-section perpendicular to the rotation central axis is prepared, with a straight line in the long-side direction passing through the rotation central axis being defined as a first centerline and with a straight line in the short-side direction passing through the rotation central axis being defined as a second centerline, the outer shape being in asymmetry in a manner at least any of first asymmetry which is asymmetry with respect to the second centerline in the long-side direction and second asymmetry which is asymmetry with respect to the first centerline in the short-side direction.

In the step of forming a capacitor element, the first arrangement is such arrangement that, with respect to the core, the first anode lead tab terminal is arranged on one side in the long-side direction, the first cathode lead tab terminal is arranged on the other side in the long-side direction, the second anode lead tab terminal is arranged on one side in the short-side direction, and the second cathode lead tab terminal is arranged on the other side in the short-side direction, and the second arrangement is such arrangement that, with respect to the core, the second anode lead tab terminal is arranged on one side in the long-side direction, the second cathode lead tab terminal is arranged on the other side in the long-side direction, the first anode lead tab terminal is arranged on one side in the short-side direction, and the first cathode lead tab terminal is arranged on the other side in the short-side direction.

An electrolytic capacitor according to the present invention is an electrolytic capacitor formed by winding band-shaped anode foil and cathode foil, and it includes a capacitor element including an anode foil and a cathode foil, a first anode lead tab terminal and a second anode lead tab terminal, and a first cathode lead tab terminal and a second cathode lead tab terminal. The anode foil and the cathode foil are wound up in a prescribed orientation from one-end side, in a manner opposed to each other. The first anode lead tab terminal and the second anode lead tab terminal are arranged at respective prescribed positions in the anode foil. The first cathode lead tab terminal and the second cathode lead tab terminal are arranged at respective prescribed positions in the cathode foil.

In a central portion of the capacitor element, an enclosed region enclosed by the anode foil and the cathode foil wound up from the one-end side is located. The enclosed region has an outer shape having a long-side direction and a short-side direction in a cross-section perpendicular to a central axis of the capacitor element. With a straight line in the long-side direction passing through the central axis being defined as a first centerline and with a straight line in the short-side direction passing through the central axis being defined as a second centerline, the outer shape exhibits an asymmetrical shape in a manner at least any of first asymmetry which is asymmetry with respect to the second centerline in the long-side direction and second asymmetry which is asymmetry with respect to the first centerline in the short-side direction.

The first anode lead tab terminal and the first cathode lead tab terminal are arranged in one of the long-side direction and the short-side direction with respect to the enclosed region, and the second anode lead tab terminal and the second cathode lead tab terminal are arranged in the other of the long-side direction and the short-side direction with respect to the enclosed region.

According to the method of manufacturing an electrolytic capacitor of the present invention, by winding up an anode foil, a cathode foil, and the like with the use of an asymmetric core, the first anode lead tab terminal, the second anode lead tab terminal, the first cathode lead tab terminal, and the second cathode lead tab terminal can be arranged closer to positions corresponding to respective vertices of a square.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a both-side pressed terminal applied to an electrolytic capacitor according to a first embodiment of the present invention.

FIG. 2 is a side view of the both-side pressed terminal shown in FIG. 1 in that embodiment.

FIG. 3 is a perspective view showing a core used in manufacturing an electrolytic capacitor according to a first example in that embodiment.

FIG. 4 is a cross-sectional view showing an outer shape of the core in a direction perpendicular to a rotation central axis in that embodiment.

FIG. 5 is a perspective view showing one step of a method of manufacturing an electrolytic capacitor according to the first example in that embodiment.

FIG. 6 is a partial perspective view showing a step performed subsequent to the step shown in FIG. 5 in that embodiment.

FIG. 7 is a perspective view showing a step performed subsequent to the step shown in FIG. 6 in that embodiment.

FIG. 8 is a perspective view showing a step performed subsequent to the step shown in FIG. 7 in that embodiment.

FIG. 9 is a perspective view showing a step performed subsequent to the step shown in FIG. 8 in that embodiment.

FIG. 10 is a cross-sectional view showing a step performed subsequent to the step shown in FIG. 9 in that embodiment.

FIG. 11 is a top view in the step shown in FIG. 10 in that embodiment.

FIG. 12 is a perspective view showing a core used in manufacturing an electrolytic capacitor according to a comparative example.

FIG. 13 is a cross-sectional view showing an outer shape of the core in a direction perpendicular to a rotation central axis of the core shown in FIG. 12.

FIG. 14 is a plan view showing arrangement relation between first (second) anode (cathode) lead tab terminals and the core of the electrolytic capacitor manufactured with the core shown in FIG. 12.

FIG. 15A is a first diagram for illustrating a problem of the electrolytic capacitor according to the comparative example and illustrating relation of arrangement of the first cathode lead tab terminal and the first anode lead tab terminal in the electrolytic capacitor manufactured with the core shown in FIG. 12.

FIG. 15B is the first diagram for illustrating the problem of the electrolytic capacitor according to the comparative example, with a partially enlarged plan view of a portion enclosed by a dotted line shown in FIG. 15A.

FIG. 16 is a first partial cross-sectional view for illustrating a problem of the electrolytic capacitor according to the comparative example.

FIG. 17 is a second partial cross-sectional view for illustrating a problem of the electrolytic capacitor according to the comparative example.

FIG. 18 is a plan view showing arrangement relation between first (second) anode (cathode) lead tab terminals and the core of the electrolytic capacitor according to the first example in that embodiment, together with arrangement of the first (second) anode (cathode) lead tab terminals of the electrolytic capacitor according to the comparative example.

FIG. 19 is a perspective view showing a core used in manufacturing an electrolytic capacitor according to a second example in that embodiment.

FIG. 20 is a cross-sectional view showing an outer shape of the core in a direction perpendicular to a rotation central axis in that embodiment.

FIG. 21 is a perspective view showing one step of a method of manufacturing an electrolytic capacitor according to the second example in that embodiment.

FIG. 22A is a second diagram for illustrating a problem of the electrolytic capacitor according to the comparative example and illustrating relation of arrangement of the second cathode lead tab terminal and the second anode lead tab terminal in the electrolytic capacitor manufactured with the core shown in FIG. 12.

FIG. 22B is the second diagram for illustrating the problem of the electrolytic capacitor according to the comparative example, with a partially enlarged plan view of a portion enclosed by a dotted line shown in FIG. 22A.

FIG. 23 is a plan view showing arrangement relation between first (second) anode (cathode) lead tab terminals and the core of the electrolytic capacitor according to the second example in that embodiment, together with arrangement of the first (second) anode (cathode) lead tab terminals of the electrolytic capacitor according to the comparative example.

FIG. 24 is a perspective view showing a core used in manufacturing an electrolytic capacitor according to a third example in that embodiment.

FIG. 25 is a cross-sectional view showing an outer shape of the core in a direction perpendicular to a rotation central axis in that embodiment.

FIG. 26 is a perspective view showing one step of a method of manufacturing an electrolytic capacitor according to the third example in that embodiment.

FIG. 27 is a plan view showing arrangement relation between first (second) anode (cathode) lead tab terminals and the core of the electrolytic capacitor according to the third example in that embodiment, together with arrangement of the first (second) anode (cathode) lead tab terminals of the electrolytic capacitor according to the comparative example.

FIG. 28 is a diagram showing a variation of a pattern of arrangement of both-side pressed terminals with respect to the core in that embodiment.

FIG. 29A is a side view showing a one-side pressed terminal applied to an electrolytic capacitor according to a second embodiment of the present invention and a side view showing a one-side pressed terminal according to one example.

FIG. 29B is a side view showing a one-side pressed terminal applied to the electrolytic capacitor according to the second embodiment of the present invention and showing a one-side pressed terminal according to another example.

FIG. 30 is a perspective view showing one step of a method of manufacturing an electrolytic capacitor in that embodiment.

FIG. 31 is a plan view showing one example of arrangement relation between first (second) anode (cathode) lead tab terminals and a core of the electrolytic capacitor in that embodiment.

FIG. 32 is a plan view showing another example of arrangement relation between the first (second) anode (cathode) lead tab terminals and the core of the electrolytic capacitor in that embodiment.

FIG. 33 is a first diagram showing a variation of a pattern of arrangement of one-side pressed terminals and both-side pressed terminals with respect to the core in that embodiment.

FIG. 34 is a plan view showing yet another example of arrangement relation between the first (second) anode (cathode) lead tab terminals and the core of the electrolytic capacitor in that embodiment.

FIG. 35 is a plan view showing yet another example of arrangement relation between the first (second) anode (cathode) lead tab terminals and the core of the electrolytic capacitor in that embodiment.

FIG. 36 is a second diagram showing a variation of a pattern of arrangement of one-side pressed terminals and both-side pressed terminals with respect to the core in that embodiment.

FIG. 37 is a perspective view showing one step of a method of manufacturing an electrolytic capacitor in a third embodiment of the present invention.

FIG. 38 is a plan view showing one example of arrangement relation between first (second) anode (cathode) lead tab terminals and a core of the electrolytic capacitor in that embodiment.

FIG. 39 is a first diagram showing a variation of a pattern of arrangement of one-side pressed terminals with respect to the core in that embodiment.

FIG. 40 is a plan view showing another example of arrangement relation between the first (second) anode (cathode) lead tab terminals and the core of the electrolytic capacitor in that embodiment.

FIG. 41 is a second diagram showing a variation of a pattern of arrangement of one-side pressed terminals with respect to the core in that embodiment.

FIG. 42 is a plan view showing the electrolytic capacitor manufactured in each embodiment when viewed from a side of the first (second) anode (cathode) lead tab terminals.

### DESCRIPTION OF THE PREFERRED EMBODIMENTS

### First Embodiment

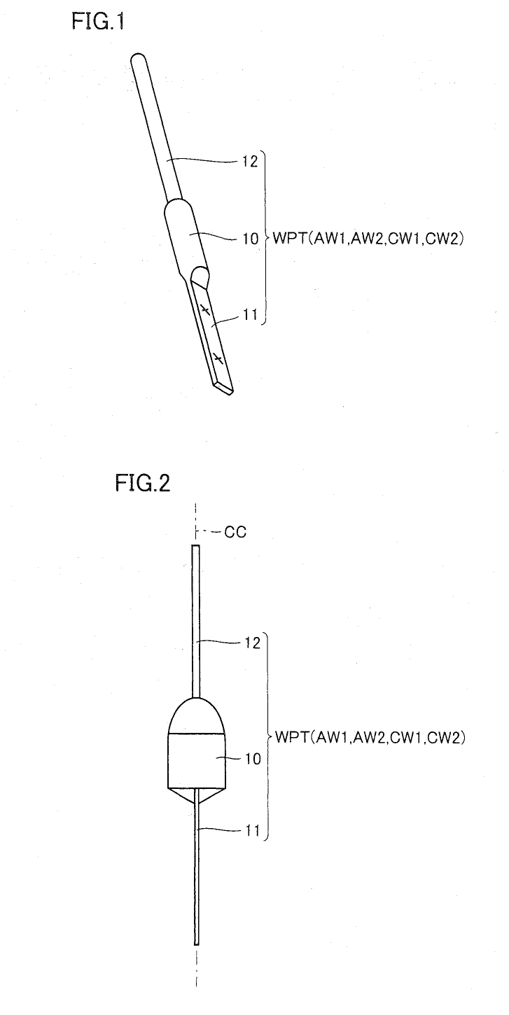

Here, an electrolytic capacitor in which a both-side pressed terminal is applied as an anode (cathode) lead tab terminal will be described. Initially, a both-side pressed terminal WPT is formed by pressing a wire rod by using two identical molds. Therefore, as shown in FIGS. 1 and 2, a both-side pressed terminal is molded substantially symmetrical with respect to a centerline CC (a connection portion). On one end side of a columnar boss portion 10, a plate-shaped connection portion 11 connected to an anode (cathode) foil is formed. In addition, on the other end side of boss portion 10, a lead 12 is attached. It is noted that, in FIG. 2, plate-shaped connection portion 11 is arranged in a direction perpendicular to the sheet surface.

### First Example

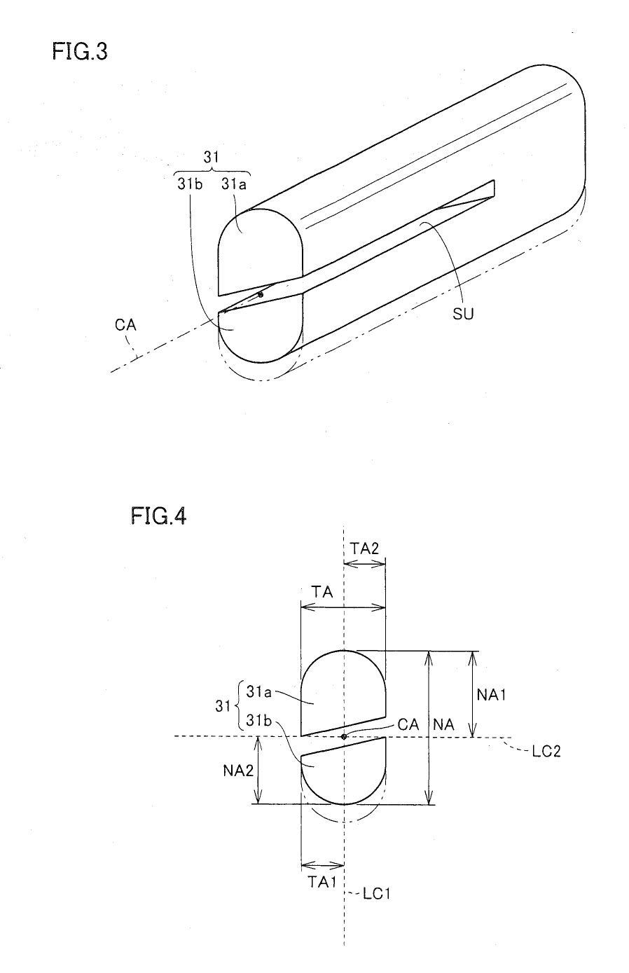

Then, a core used for manufacturing an electrolytic capacitor according to a first example, around which an anode (cathode) foil and the like are wound, will be described. As shown in FIG. 3, a core 31 includes a first sandwiching portion 31a and a second sandwiching portion 31b divided by a slit SU. An anode (cathode) foil and the like are wound up as core 31 is turned in a prescribed orientation around a rotation central axis CA while the anode (cathode) foil and the like are sandwiched between first sandwiching portion 31a and second sandwiching portion 31b.

As shown in FIG. 4, core 31 has a track-shaped outer shape in a cross-section perpendicular to rotation central axis CA. It is noted that the track-shaped outer shape is a shape defined without taking slit SU into account. This core 31 has, for example, a length NA in a long-side direction of the track shape of 1.05 mm and a length TA in a short-side direction of 0.7 mm.

When it is assumed that a straight line in the long-side direction passing through rotation central axis CA is defined as a first centerline LC1 (virtual) and a straight line in the short-side direction passing through rotation central axis CA is defined as a second centerline LC2 (virtual), track-shaped core 31 is asymmetric with respect to second centerline LC2 in the long-side direction. For example, a first length NA1 in the long-side direction from second centerline LC2 to one end in the long-side direction is 0.6 mm, and a second length NA2 in the long-side direction from second centerline LC2 to the other end in the long-side direction is 0.45 mm.

On the other hand, track-shaped core 31 is symmetric with respect to first centerline LC1 in the short-side direction. For example, a first length TA1 in the short-side direction from first centerline LC1 to one end in the short-side direction is 0.35 mm, and a second length TA2 in the short-side direction from first centerline LC1 to the other end in the short-side direction is also 0.35 mm. A core used for manufacturing an electrolytic capacitor according to a comparative example which will be described later is referred to as an A type and this core 31 is referred to as a B type.

A method of manufacturing an electrolytic capacitor with the use of core 31 will now be described. As shown in FIG. 5, a both-side pressed first anode lead tab terminal AW1 is connected at a prescribed distance (a distance A1) from one-end side of an anode foil 3 and a both-side pressed second anode lead tab terminal AW2 is connected at a distance greater than the prescribed distance from the one-end side (a distance A2). In addition, a both-side pressed first cathode lead tab terminal CW1 is connected at a prescribed distance (a distance C1) from one-end side of a cathode foil 4 and a both-side pressed second cathode lead tab terminal CW2 is connected at a distance greater than the prescribed distance from the one-end side (a distance C2).

Here, as the anode (cathode) foil and the like are wound up from the one-end side thereof, a distance between second anode (cathode) lead tab terminal AW2, CW2 and rotation central axis CA becomes greater than a distance between first anode (cathode) lead tab terminal AW1, CW1 and rotation central axis CA. Then, the first (second) anode (cathode) lead tab terminals are connected at respective prescribed positions in the anode (cathode) foil such that the second anode (cathode) lead tab terminal is located in the short-side direction of core 31 and the first anode (cathode) lead tab terminal is located in the long-side direction of core 31.

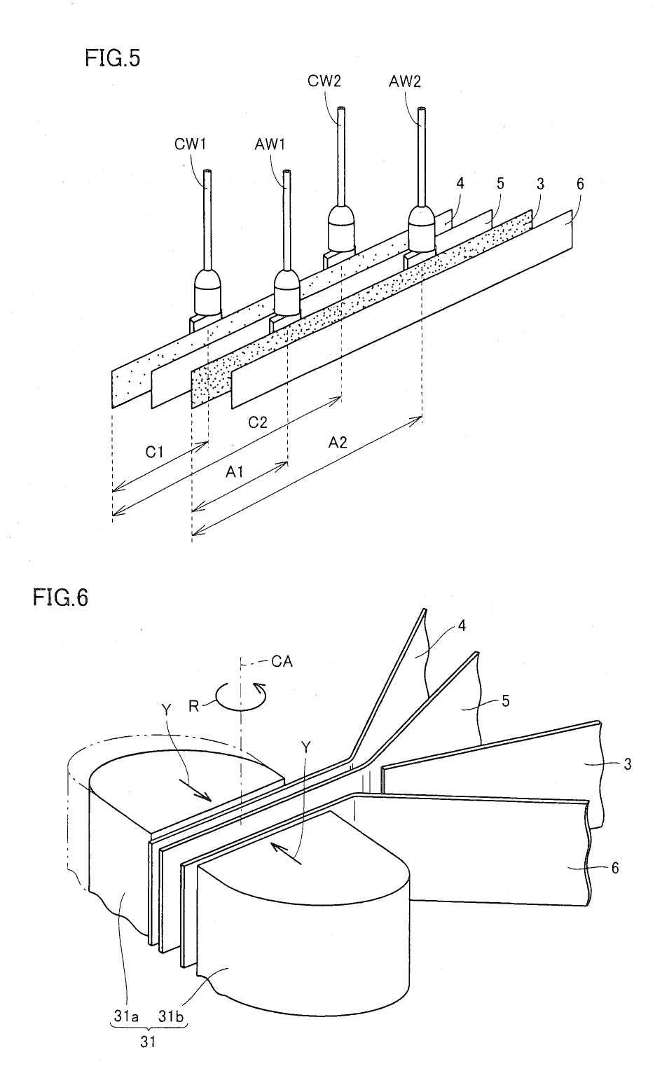

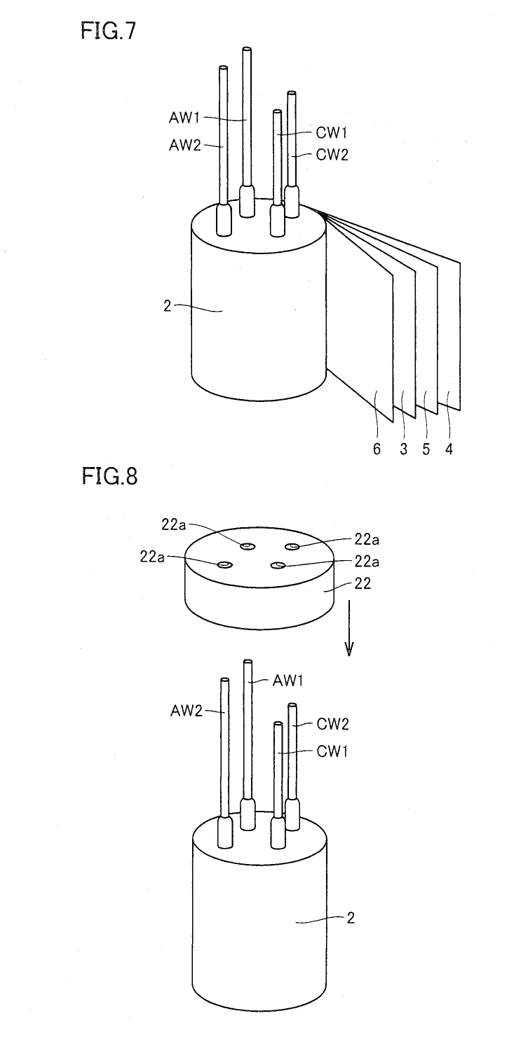

Then, as shown in FIG. 6, for example, anode foil 3 and cathode foil 4 are arranged in such a manner that one sheet of separator paper 5 is sandwiched between anode foil 3 and cathode foil 4 and anode foil 3 is sandwiched between one sheet of separator paper 5 and the other sheet of separator paper 6. Then, one-end sides of arranged anode foil 3, cathode foil 4 and sheets of separator paper 5, 6 are sandwiched between sandwiching portion 31a and sandwiching portion 31b of core 31 as shown with an arrow Y. Then, core 31 is turned to the left (counterclockwise) as shown with an arrow R in that state. By turning core 31, the band-shaped anode (cathode) foil and the like are wound up from the one-end side, to thereby form a capacitor element 2 as shown in FIG. 7.

Then, a cut surface or the like of the anode foil or the like of capacitor element 2 is subjected to chemical conversion treatment and further to heat treatment at a temperature from 150° C. to 300° C. Then, capacitor element 2 is impregnated with a solution mixture of a monomer forming a conductive polymer through polymerization, such as 3,4-ethylenedioxythiophene, and a ferric p-toluenesulfonate alcohol solution representing an oxidizing agent solution. Thereafter, through thermochemical polymerization, a conductive polymer layer (not shown) is formed between electrodes of capacitor element 2. Other than these materials, a conductive polymer material such as polypyrrole, polyfuran or polyaniline, or TCNQ complex salt (7,7,8,8-tetracyanoquinodimethane) may be used as an electrolyte.

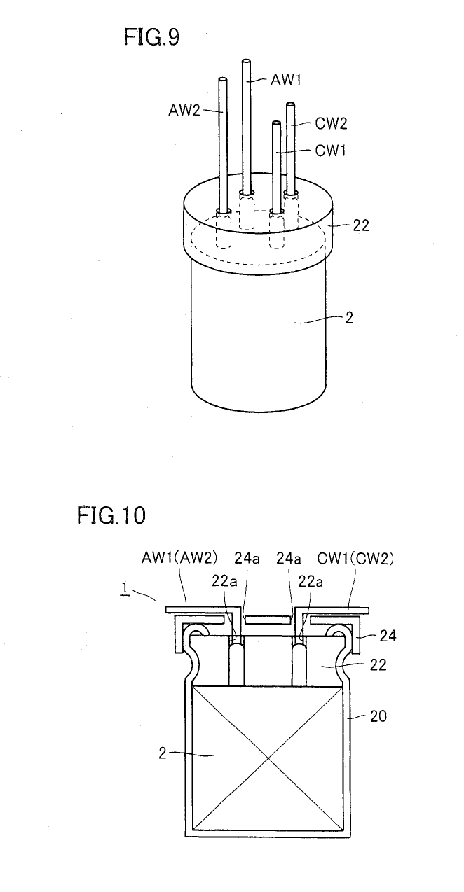

Then, as shown in FIG. 8, a sealing rubber gasket 22 is attached to capacitor element 2. In sealing rubber gasket 22, four openings 22a are formed for inserting first anode (cathode) lead tab terminals AW1, CW1 and second anode (cathode) lead tab terminals AW2, CW2 respectively. As shown in FIG. 9, sealing rubber gasket 22 is attached to capacitor element 2 by inserting leads 12 and boss portions 10 of first (second) anode (cathode) lead tab terminals AW1, CW1, AW2, CW2 into corresponding openings 22a respectively.

Then, capacitor element 2 to which sealing rubber gasket 22 is attached is accommodated in an aluminum case 20 with a bottom (see FIG. 10) having a prescribed size. Then, an open-end side of aluminum case 20 is sealed by pressing in a lateral direction and curling and prescribed aging treatment is performed. Then, a seat plate 24 made of plastic is attached to a curled surface of aluminum case 20.

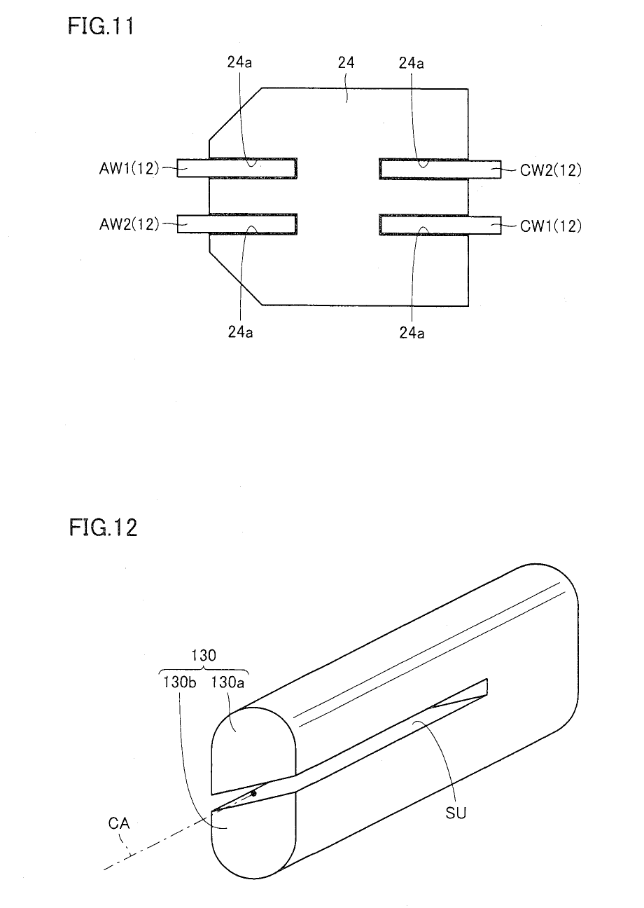

As shown in FIG. 11, four openings 24a corresponding to positions of first (second) anode (cathode) lead tab terminals AW1, CW1, AW2, CW2 are formed in seat plate 24. Seat plate 24 is attached to capacitor element 2 by inserting leads 12 of first (second) anode (cathode) lead tab terminals AW1, CW1, AW2, CW2 in respective corresponding openings 24a. Thereafter, as shown in FIGS. 10 and 11, each lead 12 protruding through opening 24a in seat plate 24 and serving as an electrode terminal is pressed and bent, to thereby complete an electrolytic capacitor 1 having a four-terminal structure.

In the electrolytic capacitor described above, in particular by winding up the anode (cathode) foil and the like around core 31 asymmetric in the long-side direction with respect to second centerline LC2, a position in a radial direction of a lead tab terminal wound around the core later (a distance between the rotation central axis and the lead tab terminal), of the first anode lead tab terminal and the first cathode lead tab terminal arranged in the long-side direction, can be closer to a position in the radial direction of the lead tab terminal that has precedingly be wound up (a distance between the rotation central axis and the lead tab terminal) than in a case of an electrolytic capacitor formed by winding up the anode (cathode) foil and the like around the core symmetric in the long-side direction with respect to the second centerline.

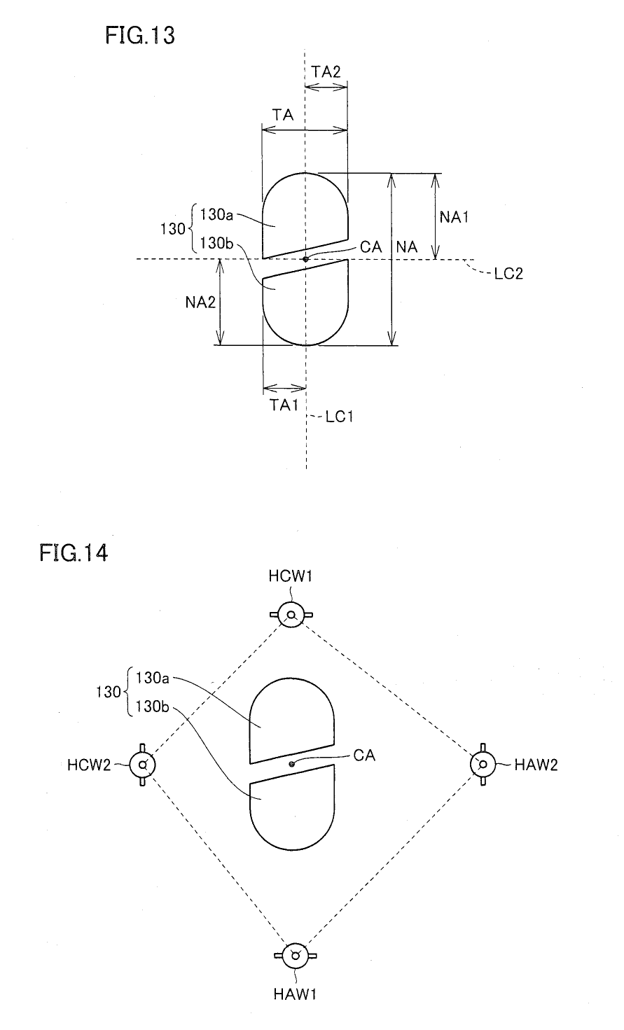

In this connection, initially, a core applied to an electrolytic capacitor according to a comparative example (an A type) will be described. As shown in FIGS. 12 and 13, a core 130 including a first sandwiching portion 130a and a second sandwiching portion 130b is symmetric with respect to second centerline LC2 in the long-side direction and symmetric with respect to first centerline LC1 in the short-side direction. Length NA in the long-side direction of the track-shaped outer shape is 1.20 mm, and each of first length NA 1 in the long-side direction from second centerline LC2 to one end in the long-side direction and second length NA2 in the long-side direction from second centerline LC2 to the other end in the long-side direction is 0.60 mm. Meanwhile, length TA in the short-side direction is 0.7 mm, and each of first length TA1 in the short-side direction from first centerline LC1 to one end in the short-side direction and second length TA2 in the short-side direction from first centerline LC1 to the other end in the short-side direction is 0.35 mm. The electrolytic capacitor formed with this core 130 will now be described.

Conditions other than core 130 are the same as in forming the electrolytic capacitor with core 31. FIG. 14 shows arrangement relation between first (second) anode (cathode) lead tab terminals HAW1, HCW1, HAW2, HCW2 and core 130 in the electrolytic capacitor according to the comparative example.

Here, for example, anode foil 3 has a thickness of 0.10 mm, cathode foil 4 has a thickness of 0.05 mm, and separator paper 5, 6 has a thickness of 0.05 mm. In winding up the anode (cathode) foil and the like around core 130, the order of winding up first (second) anode lead tab terminals HAW1, HAW2 connected to the anode foil and first (second) cathode lead tab terminals HCW1, HCW2 connected to the cathode foil around core 130 is set to the order of first cathode lead tab terminal HCW1, first anode lead tab terminal HAW1, second cathode lead tab terminal HCW2, and second anode lead tab terminal HAW2.

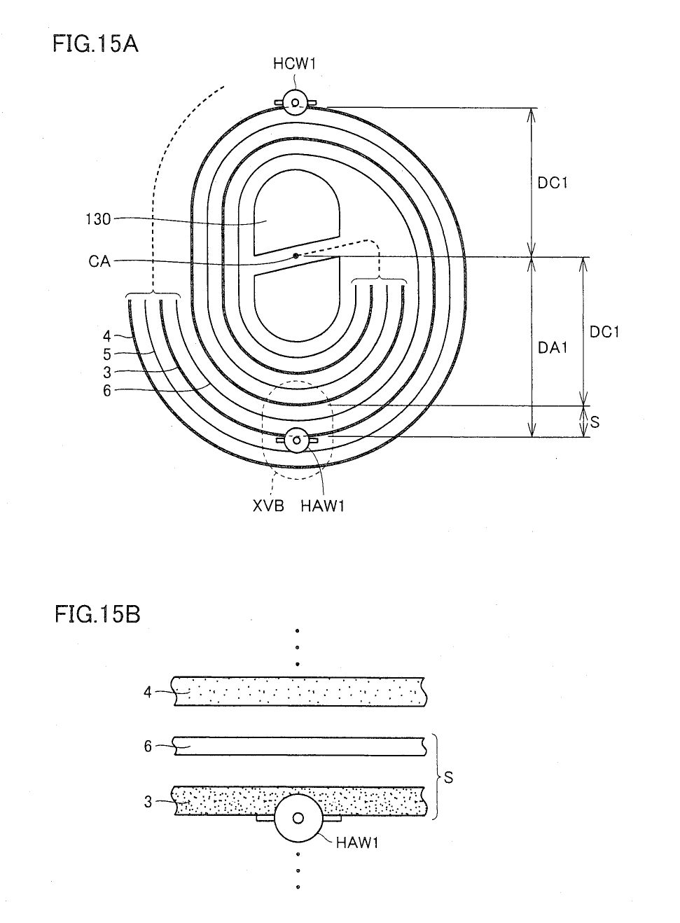

Then, since first anode lead tab terminal HAW1 is wound up in succession to first cathode lead tab terminal HCW1, a distance DA1 between a position where first anode lead tab terminal HAW1 is arranged and rotation central axis CA is longer than a distance DC1 between a position where first cathode lead tab terminal HCW1 is arranged and rotation central axis CA by a thickness S (0.15 mm) which is the total of the thickness of the separator paper (0.05 mm) and the thickness of the anode foil (0.10 mm), as shown in FIGS. 15A and 15B. Namely, first anode lead tab terminal HAW1 is arranged at the position in the radial direction distant outward from rotation central axis CA by thickness S, relative to the position in the radial direction where first cathode lead tab terminal HCW1 is arranged.

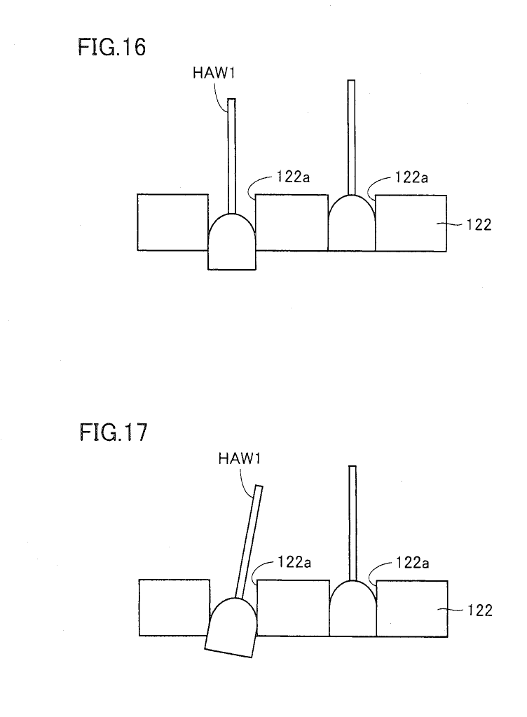

Therefore, in the electrolytic capacitor according to the comparative example, in attaching the sealing rubber gasket to the capacitor element, the position of first anode lead tab terminal HAW1 is displaced from opening 22a formed in sealing rubber gasket 22. Then, as shown in FIG. 16 or 17, first anode lead tab terminal HAW1 cannot satisfactorily be inserted into opening 22a in sealing rubber gasket 22 and defective sealing may be caused.

In contrast, core 31 is asymmetric with respect to second centerline LC2 in the long-side direction, and first length NA1 in the long-side direction is 0.6 mm and second length NA2 in the long-side direction is 0.45 mm. A difference between first length NA1 in the long-side direction and second length NA2 in the long-side direction is 0.15 mm, which corresponds to thickness S (0.15 mm).

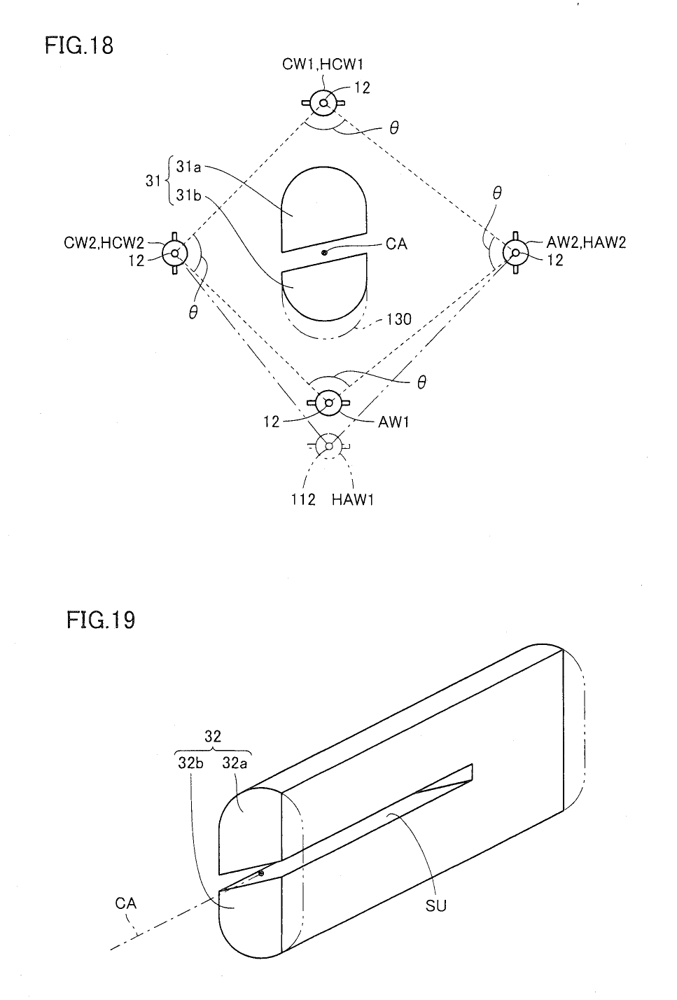

Thus, as shown in FIG. 18, the position of first anode lead tab terminal AW1 arranged on the other end side in the long-side direction in core 31 is shifted inward by approximately thickness S, relative to the position of first anode lead tab terminal HAW1 in the case of the comparative example, and a distance between the position where first anode lead tab terminal AW1 is arranged and rotation central axis CA is substantially the same as the distance between first cathode lead tab terminal CW1 and rotation central axis CA. Consequently, first anode lead tab terminal AW1 can satisfactorily be inserted into opening 22a in sealing rubber gasket 22 and defective sealing can be suppressed.

In addition, as compared with the case of the electrolytic capacitor according to the comparative example, leads 12 of first anode (cathode) lead tab terminals AW1, CW1 are arranged closer to the positions corresponding to respective vertices of the square. Thus, increase in ESL can be suppressed and characteristics as an electrolytic capacitor can be improved. Though leads 12 are most preferably arranged at positions corresponding to respective vertices of the square, defective sealing can be suppressed with characteristics (ESL) as the electrolytic capacitor being ensured, so long as an angle θ of each of four vertices is within a range from 70 to 110° (90°±20°).

### Second Example

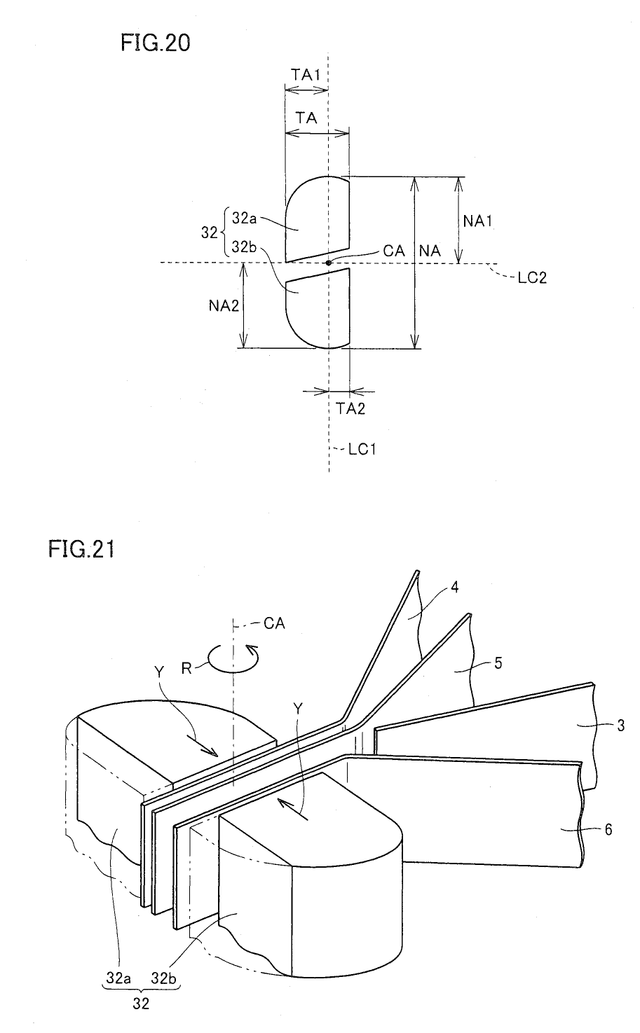

A core used for manufacturing an electrolytic capacitor according to a second example will now be described. As shown in FIG. 19, a core 32 includes a first sandwiching portion 32a and a second sandwiching portion 32b divided by slit SU. As shown in FIG. 20, core 32 has an outer shape with a part of a track shape being cut away, in a cross-section perpendicular to rotation central axis CA. This core 32 has, for example, length NA in the long-side direction of the outer shape substantially in a track shape of 1.20 mm and length TA in the short-side direction of 0.55 mm.

Core 32 substantially in the track shape is symmetric with respect to second centerline LC2 in the long-side direction, and for example, first length NA1 in the long-side direction from second centerline LC2 to one end in the long-side direction is 0.6 mm and second length NA2 in the long-side direction from second centerline LC2 to the other end in the long-side direction is also 0.6 mm.

On the other hand, core 32 substantially in the track shape is asymmetric with respect to first centerline LC1 in the short-side direction, and for example, first length TA1 in the short-side direction from first centerline LC1 to one end in the short-side direction is 0.35 mm and second length TA2 in the short-side direction from first centerline LC1 to the other end in the short-side direction is 0.2 mm. This core 32 is referred to as a C type.

A method of manufacturing an electrolytic capacitor with the use of core 32 will now be described. As in the first example, both-side pressed first (second) anode (cathode) lead tab terminals AW1, AW2, CW1, CW2 are connected at respective prescribed positions in the long-side direction in anode (cathode) foils 3 (4) (see FIG. 5).

Then, as shown in FIG. 21, for example, anode foil 3 and cathode foil 4 are arranged in such a manner that one sheet of separator paper 5 is sandwiched between anode foil 3 and cathode foil 4 and anode foil 3 is sandwiched between one sheet of separator paper 5 and the other sheet of separator paper 6. Then, one-end sides of arranged anode foil 3, cathode foil 4 and sheets of separator paper 5, 6 are sandwiched between sandwiching portion 32a and sandwiching portion 32b of core 32 as shown with arrow Y.

Then, core 32 is turned to the left (counterclockwise) as shown with arrow R in that state. By turning core 32, the band-shaped anode (cathode) foil and the like are wound up from the one-end side, to thereby form capacitor element 2 (see FIG. 7). Thereafter, as in the first example, capacitor element 2 is subjected to chemical conversion treatment, and electrolytic capacitor 1 having a four-terminal structure (see FIGS. 11 and 12) is completed through the steps similar to the steps shown in FIGS. 8 and 9.

In the electrolytic capacitor described above, in particular by winding up the anode (cathode) foil and the like around core 32 asymmetric in the short-side direction with respect to first centerline LC1, a position in a radial direction of a lead tab terminal wound around the core later, of the second anode lead tab terminal and the second cathode lead tab terminal arranged in the short-side direction, can be closer to a position in the radial direction of the lead tab terminal that has precedingly been wound up than in the case of the electrolytic capacitor formed by winding up the anode (cathode) foil and the like around the core (the A type).

In this connection, as in the first example, comparison with the electrolytic capacitor manufactured by applying the core (the A type) will be described. Taking into account the order of winding-up of first (second) anode (cathode) lead tab terminals HAW1, HAW2, HCW1, HCW2 described previously around core 130, second anode lead tab terminal HAW2 is wound up in succession to second cathode lead tab terminal HCW2.

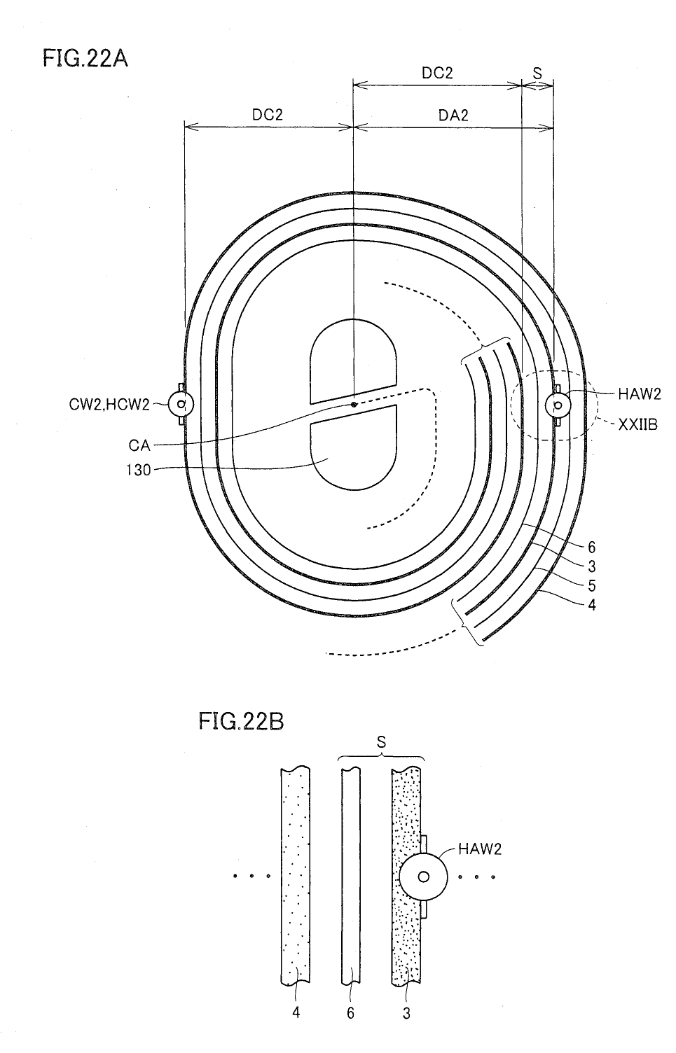

Therefore, a distance DA2 between a position where second anode lead tab terminal HAW2 is arranged and rotation central axis CA is longer than a distance DC2 between a position where second cathode lead tab terminal HCW2 is arranged and rotation central axis CA by thickness S (0.15 mm) which is the total of the thickness of the separator paper (0.05 mm) and the thickness of the anode foil (0.10 mm), as shown in FIGS. 22A and 22B. Namely, second anode lead tab terminal HAW2 is arranged at the position in the radial direction distant outward from rotation central axis CA by thickness S, relative to the position in the radial direction where second cathode lead tab terminal HCW2 is arranged.

Therefore, in the electrolytic capacitor according to the comparative example, in attaching the sealing rubber gasket to the capacitor element, the position of second anode lead tab terminal HAW2 is displaced from opening 22a formed in sealing rubber gasket 22. Then, second anode lead tab terminal HAW2 cannot satisfactorily be inserted into opening 22a in sealing rubber gasket 22 and defective sealing may be caused (see FIGS. 16 and 17).

In contrast, core 32 is asymmetric with respect to first centerline LC1 in the short-side direction, and first length TA1 in the short-side direction is 0.35 mm and second length TA2 in the short-side direction is 0.2 mm. This difference between first length TA1 in the short-side direction and second length TA2 in the short-side direction is 0.15 mm, which corresponds to thickness S (0.15 mm).

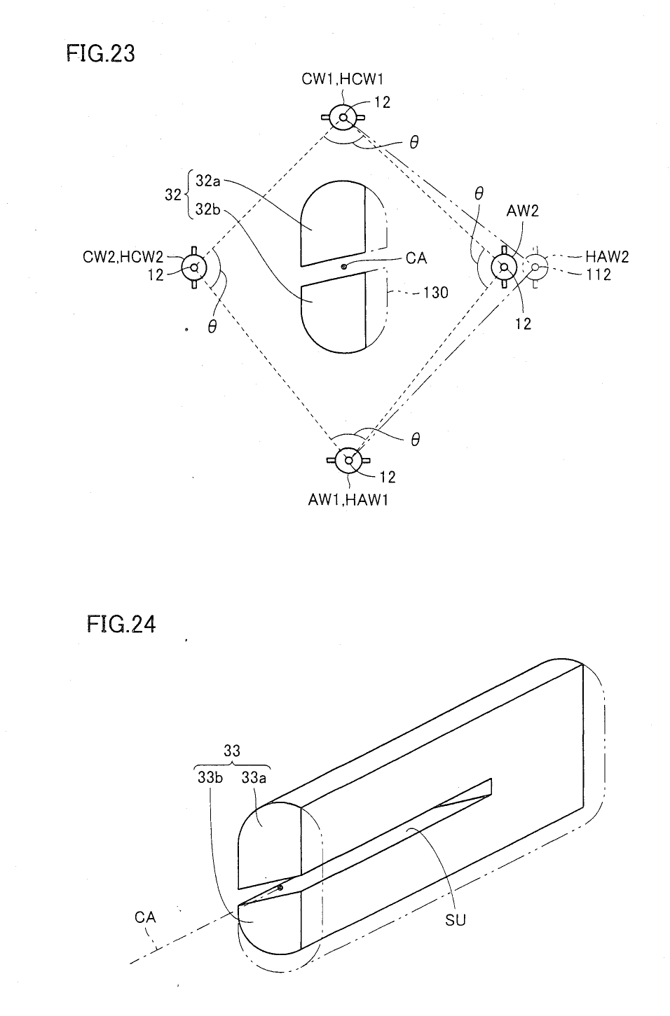

Thus, as shown in FIG. 23, the position of second anode lead tab terminal AW2 arranged on the other end side in the short-side direction in core 32 is shifted inward by approximately thickness S relative to the position of second anode lead tab terminal HAW2 in the case of the comparative example, and a distance between the position where second anode lead tab terminal AW2 is arranged and rotation central axis CA is substantially the same as the distance between second cathode lead tab terminal CW2 and rotation central axis CA. Consequently, second anode lead tab terminal AW2 can satisfactorily be inserted into opening 22a in sealing rubber gasket 22 and defective sealing can be suppressed.

In addition, as compared with the case of the electrolytic capacitor according to the comparative example, leads 12 of second anode (cathode) lead tab terminals AW2, CW2 are arranged closer to the positions corresponding to respective vertices of the square. Thus, increase in ESL can be suppressed and characteristics as an electrolytic capacitor can be improved. Though leads 12 are most preferably arranged at positions corresponding to respective vertices of the square, defective sealing can be suppressed with characteristics (ESL) as the electrolytic capacitor being ensured, so long as angle θ of each of four vertices is within a range from 70 to 110° (90°±20°).

### Third Example

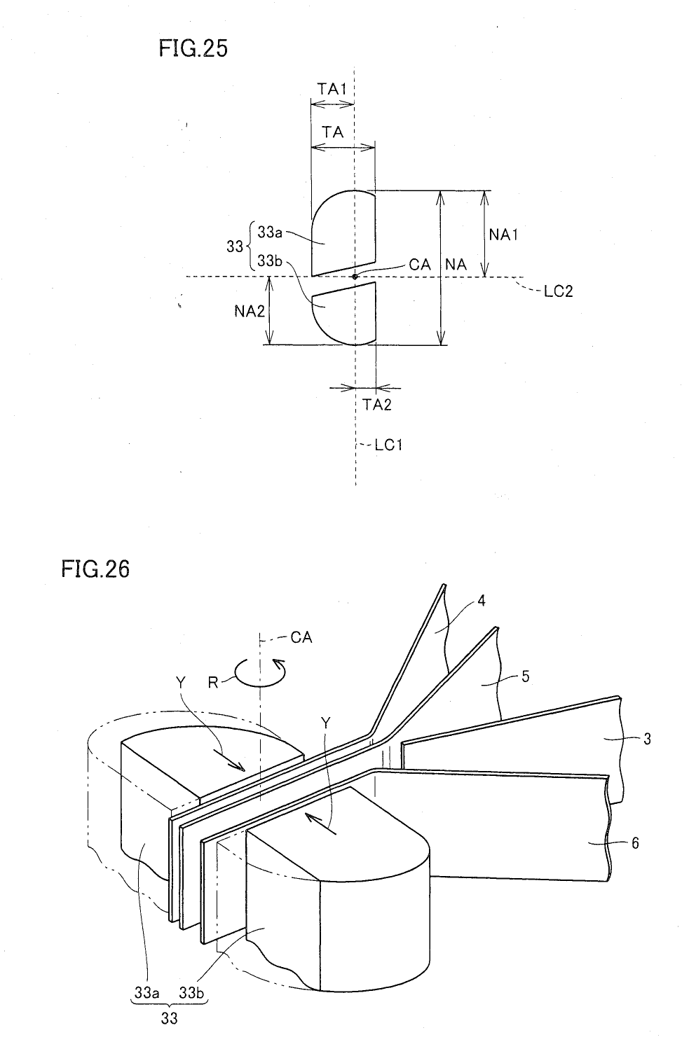

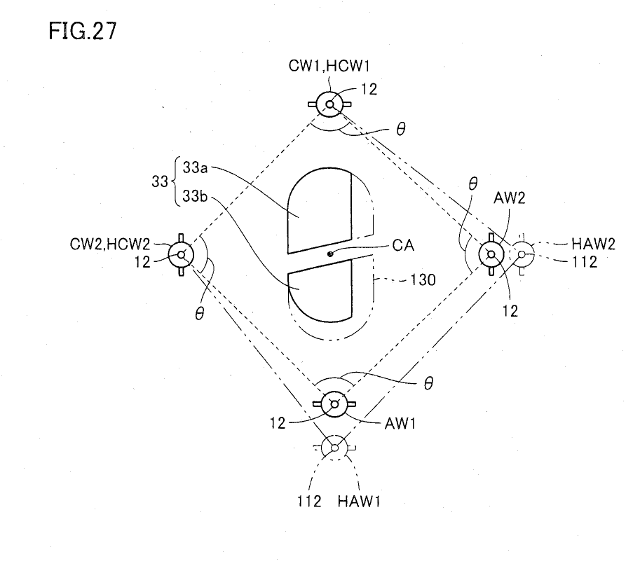

A core used for manufacturing an electrolytic capacitor according to a third example will now be described. As shown in FIG. 24, a core 33 includes a first sandwiching portion 33a and a second sandwiching portion 33b divided by slit SU. As shown in FIG. 25, core 33 has an outer shape resulting from combination of core 31 (the B type) with core 32 (the C type). Therefore, core 33 is asymmetric with respect to second centerline LC2 in the long-side direction of the track shape and also asymmetric with respect to first centerline LC1 in the short-side direction. Core 33 has, for example, length NA in the long-side direction of 1.05 mm and length TA in the short-side direction of 0.55 mm. First length NA1 in the long-side direction is 0.6 mm and second length NA2 in the long-side direction is 0.45 mm. In addition, first length TA1 in the short-side direction is 0.35 mm and second length TA2 in the short-side direction is 0.2 mm. This core 33 is referred to as a D type.

A method of manufacturing an electrolytic capacitor with the use of core 33 will now be described. As in the first example, both-side pressed first (second) anode (cathode) lead tab terminals AW1, AW2, CW1, CW2 are connected at respective prescribed positions in the long-side direction in anode (cathode) foils 3 (4) (see FIG. 5).

Then, as shown in FIG. 26, for example, anode foil 3 and cathode foil 4 are arranged in such a manner that one sheet of separator paper 5 is sandwiched between anode foil 3 and cathode foil 4 and anode foil 3 is sandwiched between one sheet of separator paper 5 and the other sheet of separator paper 6. Then, one-end sides of arranged anode foil 3, cathode foil 4 and sheets of separator paper 5, 6 are sandwiched between sandwiching portion 33a and sandwiching portion 33b of core 33 as shown with arrow Y.

Then, core 33 is turned to the left (counterclockwise) as shown with arrow R in that state. By turning core 33, the band-shaped anode (cathode) foil and the like are wound up from the one-end side, to thereby form capacitor element 2 (see FIG. 7). Thereafter, as in the first example, capacitor element 2 is subjected to chemical conversion treatment, and electrolytic capacitor 1 having a four-terminal structure (see FIGS. 11 and 12) is completed through the steps similar to the steps shown in FIGS. 8 and 9.

In the electrolytic capacitor described above, by winding up the anode (cathode) foil and the like around core 33 asymmetric in the long-side direction with respect to second centerline LC2 and asymmetric with respect to first centerline LC1 in the short-side direction, a position in a radial direction of a lead tab terminal wound around the core later, of the first anode lead tab terminal and the first cathode lead tab terminal arranged in the long-side direction, can be closer to a position in the radial direction of the lead tab terminal that has precedingly been wound up than in the case of the electrolytic capacitor formed by winding up the anode (cathode) foil and the like around the core (the A type). In addition, a position in a radial direction of a lead tab terminal wound around the core later, of the second anode lead tab terminal and the second cathode lead tab terminal arranged in the short-side direction, can be closer to a position in the radial direction of the lead tab terminal that has precedingly be wound up.

Thus, as described in the first example, the position of first anode lead tab terminal AW1 arranged on the other end side in the long-side direction in core 33 is shifted inward by approximately thickness S relative to the position of first anode lead tab terminal HAW1 in the case of the comparative example, and a distance between the position where first anode lead tab terminal AW1 is arranged and rotation central axis CA is substantially the same as a distance between first cathode lead tab terminal CW1 and rotation central axis CA.

In addition, as described in the second example, the position of second anode lead tab terminal AW2 arranged on the other end side in the short-side direction in core 33 is shifted inward by approximately thickness S relative to the position of second anode lead tab terminal HAW2 in the case of the comparative example, and a distance between the position where second anode lead tab terminal AW2 is arranged and rotation central axis CA is substantially the same as a distance between second cathode lead tab terminal CW2 and rotation central axis CA. Consequently, first anode lead tab terminal AW1 and second anode lead tab terminal AW2 can satisfactorily be inserted into respective openings 22a in sealing rubber gasket 22 and defective sealing can further reliably be suppressed.

Moreover, as compared with the case of the electrolytic capacitor according to the comparative example, leads 12 of first anode (cathode) lead tab terminals AW1, CW1 and leads 12 of second anode (cathode) lead tab terminals AW2, CW2 are arranged closer to the positions corresponding to respective vertices of the square. Thus, increase in ESL can be suppressed and characteristics as an electrolytic capacitor can be improved.

In the first to third examples, a case where, with respect to the core, the first cathode lead tab terminal is arranged on one side in the long-side direction (on a side of first length NA1 in the long-side direction), the first anode lead tab terminal is arranged on the other side in the long-side direction (on a side of second length NA2 in the long-side direction), the second cathode lead tab terminal is arranged on one side in the short-side direction (on a side of first length TA1 in the short-side direction), and the second anode lead tab terminal is arranged on the other side in the short-side direction (on a side of second length TA2 in the short-side direction), has been described by way of example.

Arrangement of the first anode lead tab terminal to the second cathode lead tab terminal with respect to the core is not limited thereto, and arrangement may vary depending on a material for the anode foil, the cathode foil, and the separator paper to be used, a size for winding up the anode foil, the cathode foil, and the like (an element diameter), or the like.

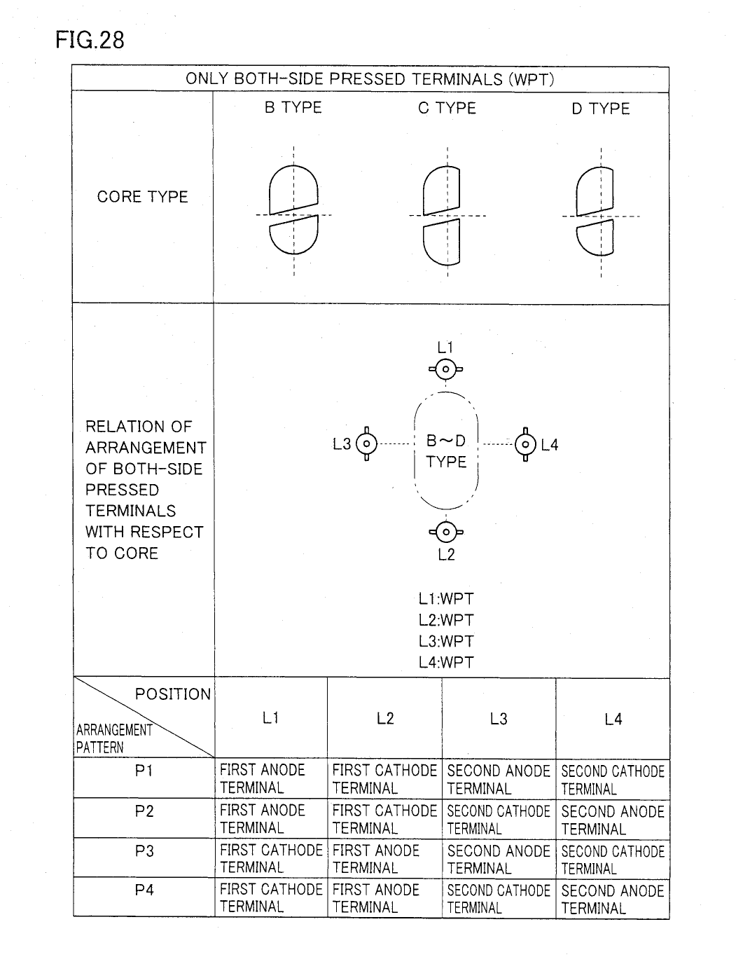

FIG. 28 shows a variation in arrangement of the first anode lead tab terminal to the second cathode lead tab terminal with respect to the core assumed when both-side pressed terminal WPT is applied as an anode (cathode) lead tab terminal. As shown in FIG. 28, four arrangement patterns P1 to P4 are assumed as arrangement patterns.

In these electrolytic capacitors, as a result of winding-up around asymmetric core 31, displacement in position in a radial direction due to thickness of the anode foil, the separator, and the like between a lead tab terminal wound up later and a lead tab terminal precedingly wound up, of the first anode (cathode) lead tab terminals (difference in distance from the rotation central axis to the lead), can be made smaller.

In addition, as a result of winding-up around asymmetric core 32, displacement in position in a radial direction due to thickness of the anode foil, the separator, and the like between a lead tab terminal wound up later and a lead tab terminal precedingly wound up, of the second anode (cathode) lead tab terminals (difference in distance from the rotation central axis to the lead), can be made smaller.

As a result of winding-up around asymmetric core 33, both of displacement in position in a radial direction of the first anode (cathode) lead tab terminal and displacement in position in a radial direction of the second anode (cathode) lead tab terminal can be made smaller. Consequently, defective sealing can reliably be suppressed and characteristics as the electrolytic capacitor can be improved. Further, in the third example, as compared with the cases of the first example and the second example, positions of leads 12 can be brought closer to positions corresponding to respective vertices of a square and angle θ of each of four vertices can be close to 90°.

### Second Embodiment

Here, an electrolytic capacitor including both of a both-side pressed terminal and a one-side pressed terminal as anode (cathode) lead tab terminals will be described.

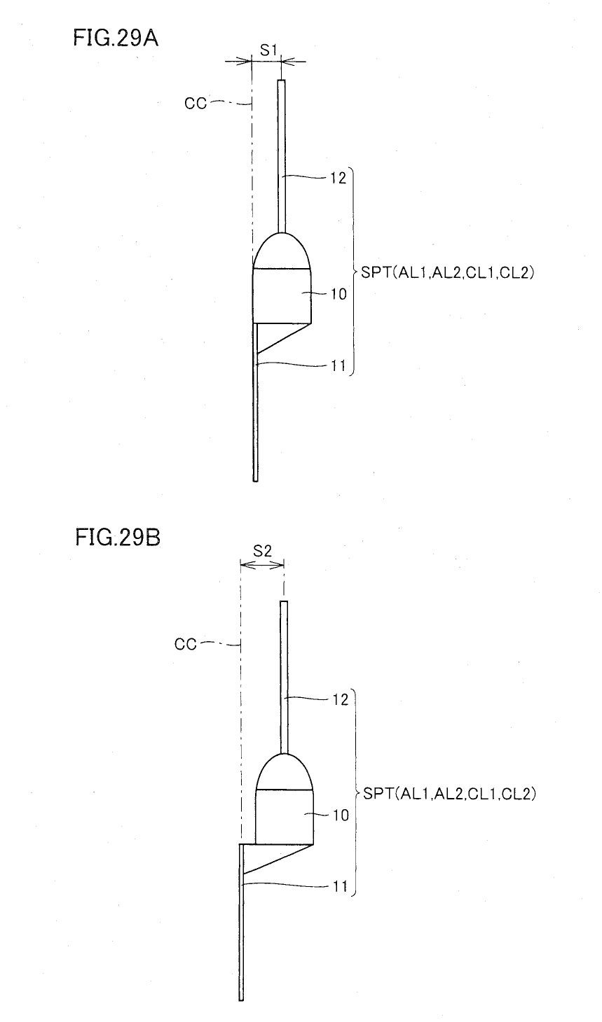

A one-side pressed terminal is formed by pressing a wire rod by mainly using one mold of two identical molds. Therefore, as shown in FIGS. 29A and 29B, the one-side pressed terminal is molded in a shape asymmetric with respect to centerline CC (connection portion). FIG. 29A shows a one-side pressed terminal relatively small in an amount of shift of lead 12 (a distance S1) relative to connection portion 11, and FIG. 29B shows a one-side pressed terminal relatively great in an amount of shift (a distance S2). In any one-side pressed terminal SPT, columnar boss portion 10, plate-shaped connection portion 11 connected to the anode (cathode) foil, and columnar lead 12 serving as the anode (cathode) terminal are molded. Lead 12 is provided on one-end side of boss portion 10, and connection portion 11 is provided on the other end side of boss portion 10. In FIGS. 29A and 29B, plate-shaped connection portion 11 is arranged in a direction perpendicular to the sheet surface.

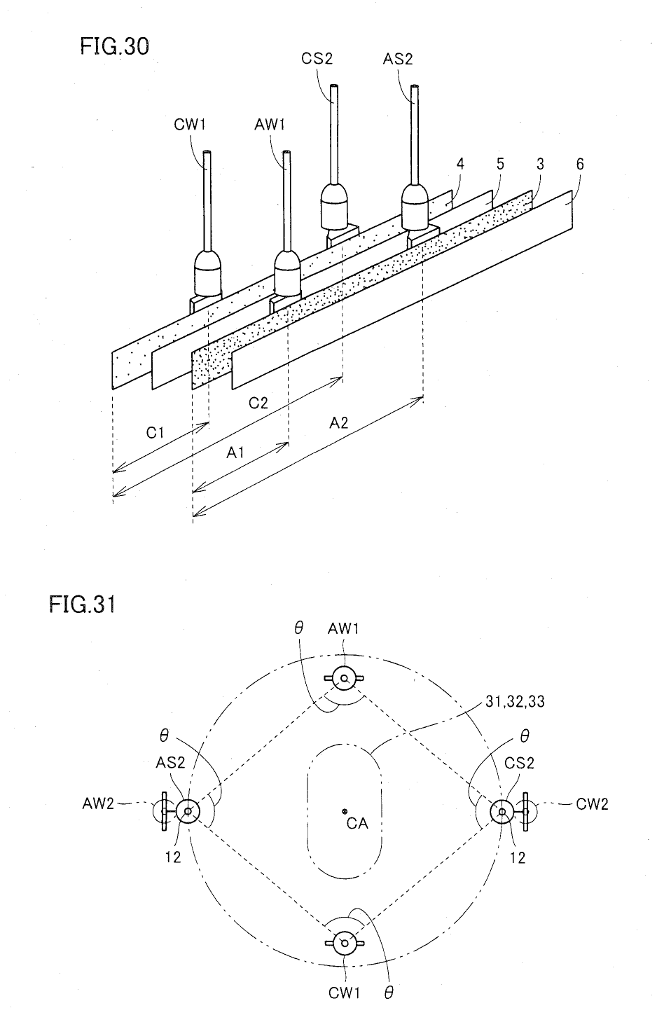

A method of manufacturing an electrolytic capacitor in which a both-side pressed terminal and a one-side pressed terminal are applied will now be described. In the one-side pressed terminal, by changing a surface to be connected to the anode (cathode) foil at the connection portion of the one-side pressed terminal, a lead or the like can be shifted radially outward or inward. FIG. 30 shows one example of a manner of connection of a first (second) anode (cathode) lead tab terminal to the anode (cathode) foil in a case where a both-side pressed terminal is applied to first anode lead tab terminal AW1 and first cathode lead tab terminal CW1 and a one-side pressed terminal is applied to a second anode lead tab terminal AS2 and a second cathode lead tab terminal CS2.

Then, as in the first example, one-end sides of anode foil 3, cathode foil 4 and sheets of separator paper 5, 6 are sandwiched between sandwiching portion 31a and sandwiching portion 31b of core 31 (see FIG. 6). Then, by turning core 31 to the left (counterclockwise) in that state and winding up band-shaped anode (cathode) foils 3, 4 and the like from the one-end side, capacitor element 2 is formed (see FIG. 7).

In addition, in this step of forming capacitor element 2, as in the second example, it may be formed by winding up band-shaped anode (cathode) foils 3, 4 and the like around core 32 from the one-end side. Further, as in the third example, it may be formed by winding up band-shaped anode (cathode) foils 3, 4 and the like around core 33 from the one-end side.

Thereafter, as in the first example, capacitor element 2 is subjected to chemical conversion treatment, and electrolytic capacitor 1 having a four-terminal structure (see FIGS. 11 and 12) is completed through the steps similar to the steps shown in FIGS. 8 and 9.

Patterns of arrangement of the anode (cathode) lead tab terminals of the electrolytic capacitors formed with cores 31 to 33 by applying a both-side pressed terminal and a one-side pressed terminal will now be described.

As described above, in the one-side pressed terminal, a lead or the like can be shifted radially outward or inward. Therefore, other than such a pattern that, with respect to the core, the first anode (cathode) lead tab terminals are arranged in the long-side direction and the second anode (cathode) lead tab terminals are arranged in the short-side direction (an arrangement pattern A), such a pattern that the second anode (cathode) lead tab terminals are arranged in the long-side direction and the first anode (cathode) lead tab terminals are arranged in the short-side direction (an arrangement pattern B) is also possible.

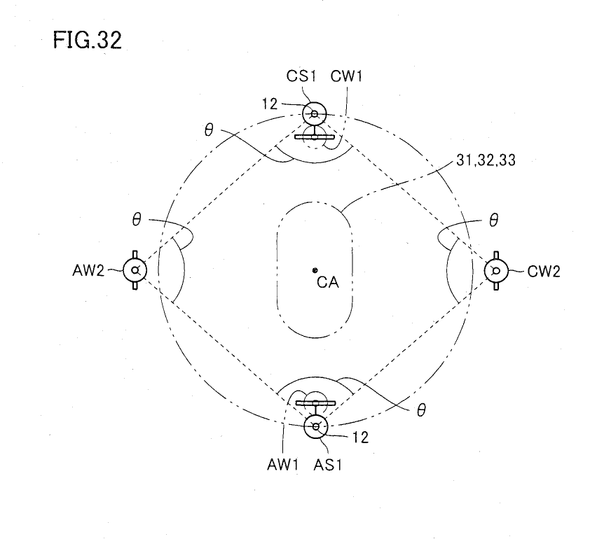

Initially, an example of arrangement pattern A is shown in FIGS. 31 and 32. In FIG. 31, a one-side pressed terminal is applied to second anode (cathode) lead tab terminal AS2, CS2, and lead 12 of second anode (cathode) lead tab terminal AS2, CS2 is arranged to be shifted radially inward. By shifting lead 12 radially inward, a position in a radial direction of lead 12 of second anode (cathode) lead tab terminal AS2, CS2 can be brought closer to the position in the radial direction of the lead of the first anode (cathode) lead tab terminal AW1, CW1 than in the case where second anode (cathode) lead tab terminal AW2, CW2 implemented by a both-side pressed terminal is applied. Namely, difference between a distance from the rotation central axis to lead 12 of second anode (cathode) lead tab terminal AS2, CS2 and a distance from the rotation central axis to the lead of first anode (cathode) lead tab terminal AW1, CW1 can be reduced.

In addition, in FIG. 32, one-side pressed terminal SPT is applied to first anode (cathode) lead tab terminal AS1, CS1, and lead 12 of first anode (cathode) lead tab terminal AS1, CS1 is arranged to be shifted radially outward. By shifting lead 12 radially outward, a position in a radial direction of lead 12 of first anode (cathode) lead tab terminal AS1, CS1 can be brought closer to the position in the radial direction of the lead of second anode (cathode) lead tab terminal AW2, CW2 than in the case where first anode (cathode) lead tab terminal AW1, CW1 implemented by both-side pressed terminal WPT is applied. Namely, difference between a distance from the rotation central axis to lead 12 of first anode (cathode) lead tab terminal AW1, CW1 and a distance from the rotation central axis to the lead of second anode (cathode) lead tab terminal AS2, CS2 can be reduced.

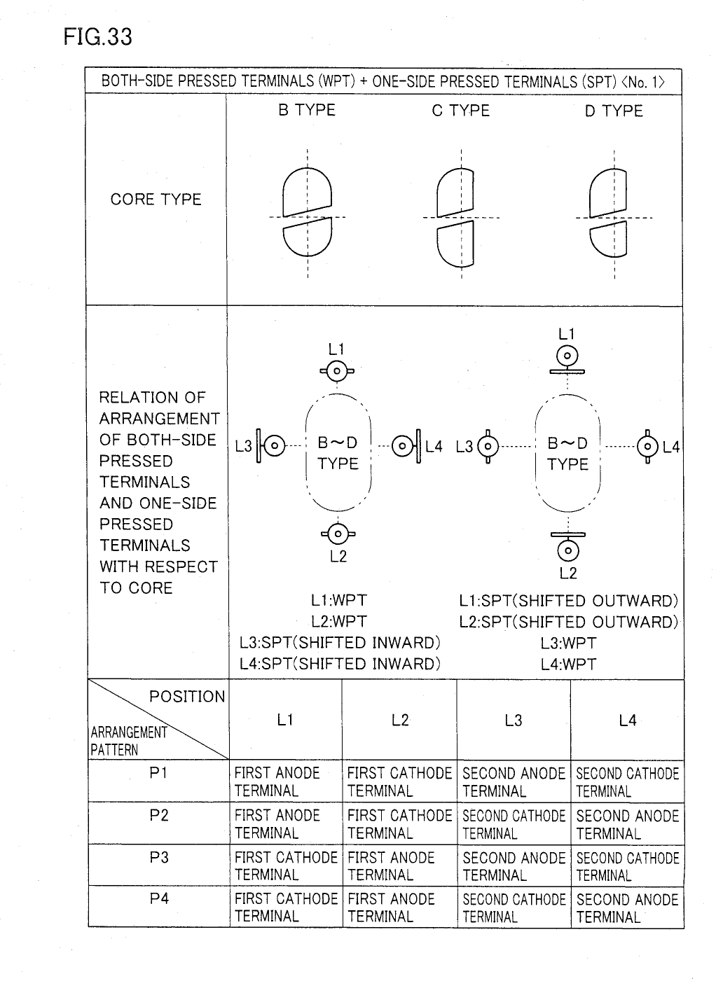

As described previously, arrangement of the first anode lead tab terminal to the second cathode lead tab terminal with respect to the core may vary, depending on a material for the anode foil, the cathode foil, and the separator paper to be used, a size for winding up the anode foil, the cathode foil, and the like (an element diameter), or the like. FIG. 33 shows a variation in arrangement of the first anode lead tab terminal to the second cathode lead tab terminal with respect to the core in the case of arrangement pattern A. As shown in FIG. 33, four arrangement patterns P1 to P4 are assumed as arrangement patterns.

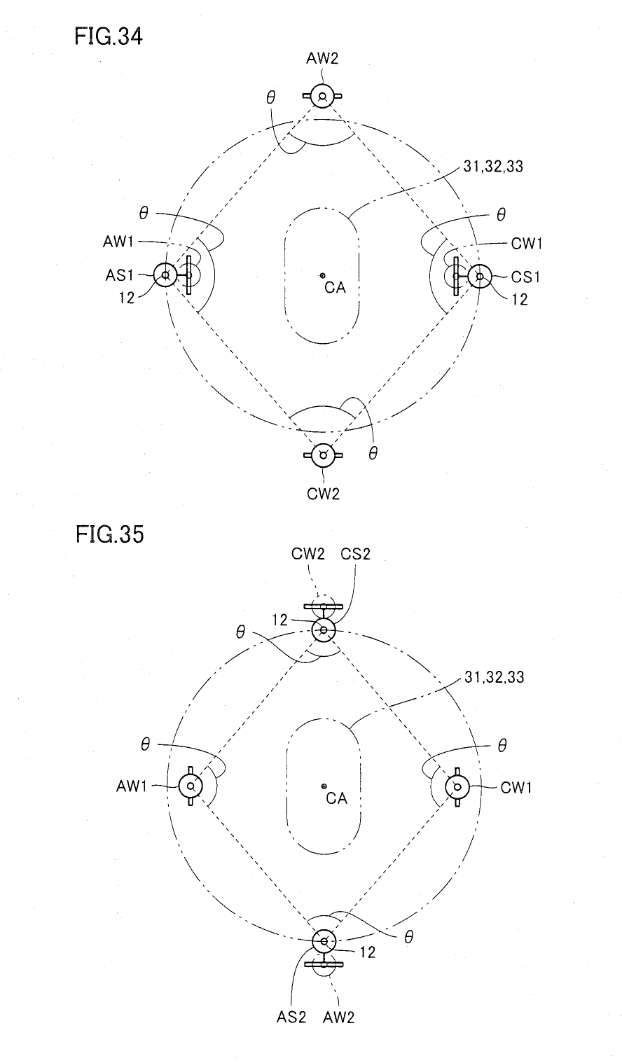

Then, FIGS. 34 and 35 each show an example of arrangement pattern B. In FIG. 34, one-side pressed terminal SPT is applied to first anode (cathode) lead tab terminal AS1, CS1, and lead 12 of first anode (cathode) lead tab terminal AS1, CS1 is arranged to be shifted radially outward. By shifting lead 12 radially outward, the position in the radial direction of lead 12 of first anode (cathode) lead tab terminal AS1, CS1 can be brought closer to the position in the radial direction of the lead of second anode (cathode) lead tab terminal AW2, CW2 than in the case where first anode (cathode) lead tab terminal AW1, CW1 implemented by a both-side pressed terminal is applied. Namely, difference between a distance from the rotation central axis to lead 12 of first anode (cathode) lead tab terminal AS1, CS1 and a distance from the rotation central axis to the lead of second anode (cathode) lead tab terminal AW2, CW2 can be reduced.

In addition, in FIG. 35, one-side pressed terminal SPT is applied to second anode (cathode) lead tab terminal AS2, CS2, and lead 12 of second anode (cathode) lead tab terminal AS2, CS2 is arranged to be shifted radially inward. By shifting lead 12 radially inward, the position in the radial direction of lead 12 of second anode (cathode) lead tab terminal AS2, CS2 can be brought closer to the position in the radial direction of the lead of first anode (cathode) lead tab terminal AW1, CW1 than in the case where second anode (cathode) lead tab terminal AW2, CW2 implemented by both-side pressed terminal WPT is applied. Namely, difference between a distance from the rotation central axis to lead 12 of second anode (cathode) lead tab terminal AS2, CS2 and a distance from the rotation central axis to the lead of first anode (cathode) lead tab terminal AW1, CW1 can be reduced.

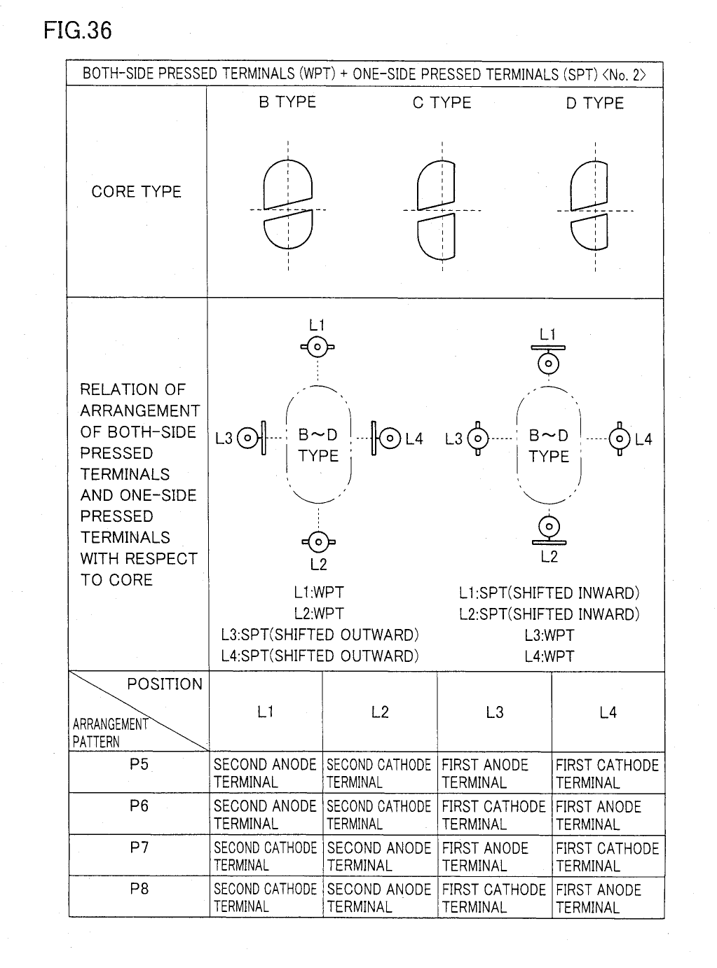

Then, FIG. 36 shows a variation in arrangement of the first anode lead tab terminal to the second cathode lead tab terminal with respect to the core in the case of arrangement pattern B. As shown in FIG. 36, four arrangement patterns P5 to P8 are assumed as arrangement patterns.

In an electrolytic capacitor in which a both-side pressed terminal and a one-side pressed terminal are applied, as a result of winding-up around core 31, 32, 33 having an asymmetric outer shape, displacement in position in a radial direction due to thicknesses of the anode foil, the separator, and the like, of the first anode (cathode) lead tab terminal and/or the second anode (cathode) lead tab terminal (difference in distance from the rotation central axis to the lead), can be made smaller, and in addition, the following effect is obtained.

Namely, by applying a one-side pressed terminal as the second anode (cathode) lead tab terminal to be arranged farther from the rotation central axis than the first anode (cathode) lead tab terminal and then shifting that lead radially inward, a distance between the rotation central axis and the lead of the second anode (cathode) lead tab terminal can be reduced so that a position in a radial direction of the lead of the second anode (cathode) lead tab terminal can be brought closer to a position in a radial direction of the lead of the first anode (cathode) lead tab terminal.

Meanwhile, by applying a one-side pressed terminal as the first anode (cathode) lead tab terminal to be arranged closer to the rotation central axis than the second anode (cathode) lead tab terminal and then shifting that lead radially outward, a distance between the rotation central axis and the lead of the first anode (cathode) lead tab terminal is made longer so that a position in a radial direction of the lead of the first anode (cathode) lead tab terminal can be brought closer to a position in a radial direction of the lead of the second anode (cathode) lead tab terminal.

Thus, positions of leads 12 can be brought closer to positions corresponding to respective vertices of a square and angle θ of each of four vertices can be close to 90°. Consequently, defective sealing can more effectively be suppressed and characteristics as an electrolytic capacitor can further be improved.

### Third Embodiment

Here, an electrolytic capacitor in which only a one-side pressed terminal is applied as an anode (cathode) lead tab terminal will be described. As described previously, in a one-side pressed terminal, by changing a surface to be connected to the anode (cathode) foil at the connection portion of the one-side pressed terminal, a lead or the like can be shifted radially outward or inward.

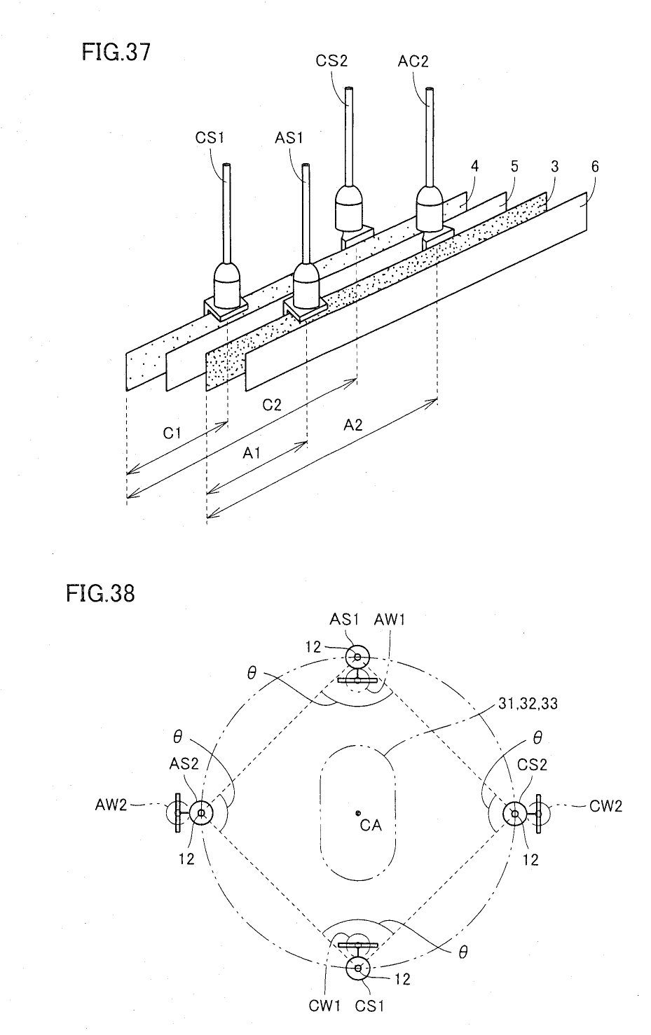

FIG. 37 shows one example of a manner of connection of a first (second) anode (cathode) lead tab terminal to the anode (cathode) foil in a case where a one-side pressed terminal is applied to first anode lead tab terminal AS1 and first cathode lead tab terminal CS1 and a one-side pressed terminal is applied to second anode lead tab terminal AS2 and second cathode lead tab terminal CS2.

Then, as in the first example, one-end sides of anode foil 3, cathode foil 4 and sheets of separator paper 5, 6 are sandwiched between sandwiching portion 31a and sandwiching portion 31b of core 31 (see FIG. 6). Then, by turning core 31 to the left (counterclockwise) in that state and winding up band-shaped anode (cathode) foil 3, 4 and the like from the one-end side, capacitor element 2 is formed (see FIG. 7).

In addition, in this step of forming capacitor element 2, as in the second example, it may be formed by winding up band-shaped anode (cathode) foils 3, 4 and the like around core 32 from the one-end side. Further, as in the third example, it may be formed by winding up band-shaped anode (cathode) foils 3, 4 and the like around core 33 from the one-end side.

Thereafter, as in the first example, capacitor element 2 is subjected to chemical conversion treatment, and electrolytic capacitor 1 having a four-terminal structure (see FIGS. 11 and 12) is completed through the steps similar to the steps shown in FIGS. 8 and 9.

Then, patterns of arrangement of the anode (cathode) lead tab terminals of the electrolytic capacitor formed with cores 31 to 33 by applying only one-side pressed terminals will now be described.

As described above, in the one-side pressed terminal, a lead or the like can be shifted radially outward or inward. Therefore, other than such a pattern that, with respect to the core, the first anode (cathode) lead tab terminals are arranged in the long-side direction and the second anode (cathode) lead tab terminals are arranged in the short-side direction (an arrangement pattern C), such a pattern that the second anode (cathode) lead tab terminals are arranged in the long-side direction and the first anode (cathode) lead tab terminals are arranged in the short-side direction (an arrangement pattern D) is also possible.

Initially, FIG. 38 shows an example of arrangement pattern C. In FIG. 38, the lead of the first anode (cathode) lead tab terminal is arranged to be shifted radially outward and the lead of the second anode (cathode) lead tab terminal is arranged to be shifted radially inward. Thus, a position in a radial direction of the lead of first anode (cathode) lead tab terminal AS1, CS1 can be brought closer to a position in a radial direction of lead 12 of second anode (cathode) lead tab terminal AS2, CS2 than in the case where first (second) anode (cathode) lead tab terminal AW1, CW1, AW2, CW2 implemented by a both-side pressed terminal is applied. Namely, difference between a distance to lead 12 of first anode (cathode) lead tab terminal AS1, CS1 and a distance from the rotation central axis to lead 12 of second anode (cathode) lead tab terminal AS2, CS2 can further be reduced.

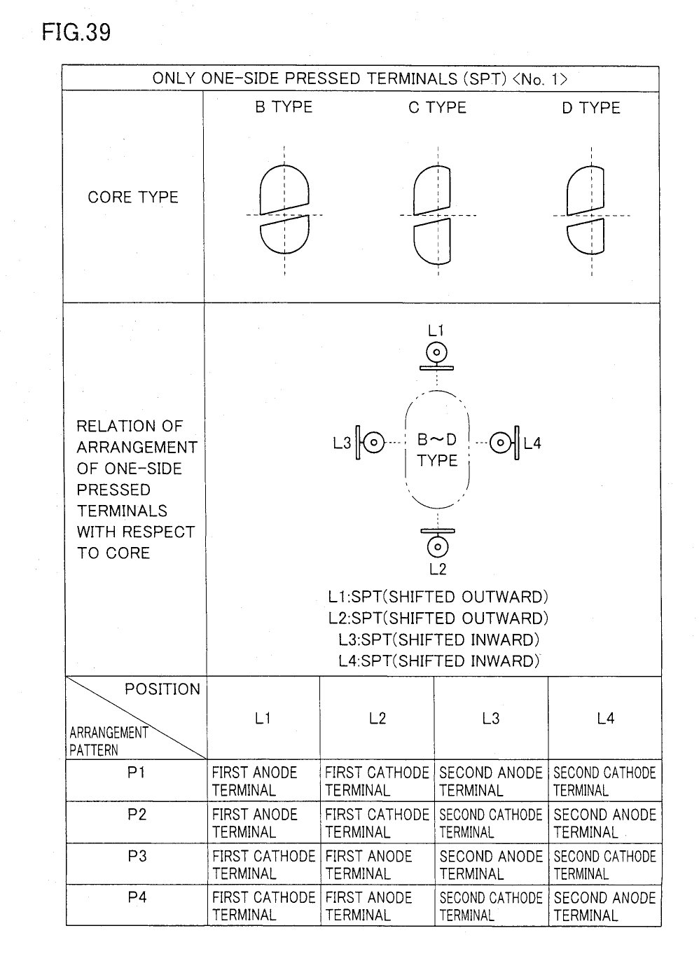

As described previously, arrangement of the first anode lead tab terminal to the second cathode lead tab terminal with respect to the core may vary, depending on a material for the anode foil, the cathode foil, and the separator paper to be used, a size for winding up the anode foil, the cathode foil, and the like (an element diameter), or the like. FIG. 39 shows a variation in arrangement of the first anode lead tab terminal to the second cathode lead tab terminal with respect to the core in the case of arrangement pattern C. As shown in FIG. 39, four arrangement patterns P1 to P4 are assumed as arrangement patterns.

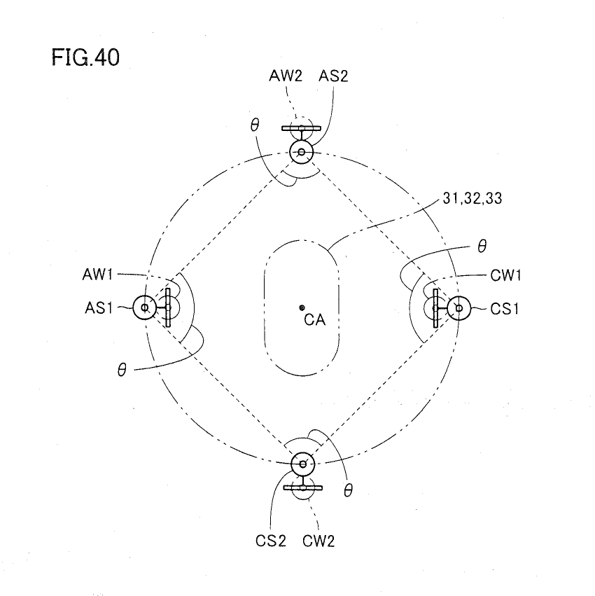

Then, FIG. 40 shows an example of arrangement pattern D. In FIG. 40, the lead of the first anode (cathode) lead tab terminal is arranged to be shifted radially outward and the lead of the second anode (cathode) lead tab terminal is arranged to be shifted radially inward. Thus, a position in a radial direction of the lead of first anode (cathode) lead tab terminal AS1, CS1 can be brought closer to a position in a radial direction of lead 12 of second anode (cathode) lead tab terminal AS2, CS2 than in the case where first (second) anode (cathode) lead tab terminal AW1, CW1, AW2, CW2 implemented by a both-side pressed terminal is applied. Namely, difference between a distance to lead 12 of first anode (cathode) lead tab terminal AS1, CS1 and a distance from the rotation central axis to lead 12 of second anode (cathode) lead tab terminal AS2, CS2 can further be reduced.

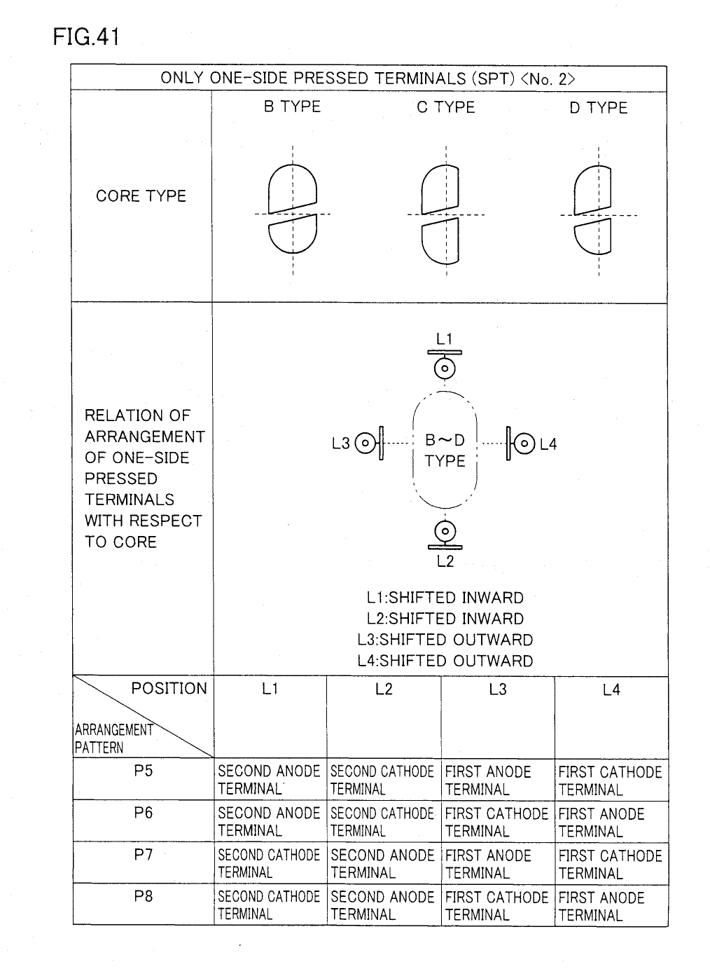

As described previously, arrangement of the first anode lead tab terminal to the second cathode lead tab terminal with respect to the core may vary, depending on a material for the anode foil, the cathode foil, and the separator paper to be used, a size for winding up the anode foil, the cathode foil, and the like (an element diameter), or the like. FIG. 41 shows a variation in arrangement of the first anode lead tab terminal to the second cathode lead tab terminal with respect to the core in the case of arrangement pattern D. As shown in FIG. 41, four arrangement patterns P5 to P8 are assumed as arrangement patterns.

In an electrolytic capacitor in which only one-side pressed terminals are applied, as a result of winding-up around asymmetric core 31, 32, 33, displacement in a radial direction due to thicknesses of the anode foil, the separator, and the like, of the first anode (cathode) lead tab terminal and/or the second anode (cathode) lead tab terminal (difference in distance from the rotation central axis to the lead), can be made smaller, and in addition, the following effect is obtained.

Namely, by applying a one-side pressed terminal as the second anode (cathode) lead tab terminal to be arranged relatively distant from the rotation central axis and then shifting that lead radially inward, a distance between the rotation central axis and the lead of the second anode (cathode) lead tab terminal can be decreased. Meanwhile, by applying a one-side pressed terminal as the first anode (cathode) lead tab terminal to be arranged relatively close to the rotation central axis and then shifting that lead radially outward, a distance between the rotation central axis and the lead of the first anode (cathode) lead tab terminal can be increased.

Thus, a difference between a distance from the rotation central axis to lead 12 of first anode (cathode) lead tab terminal AS1, CS1 and a distance from the rotation central axis to lead 12 of second anode (cathode) lead tab terminal AS2, CS2 can further be decreased, so that leads 12 can be arranged most closely to positions corresponding to respective vertices of a square. Consequently, angle θ of each of four vertices can further be close to 90°, defective sealing can further reliably be suppressed, and characteristics as an electrolytic capacitor can further be improved.

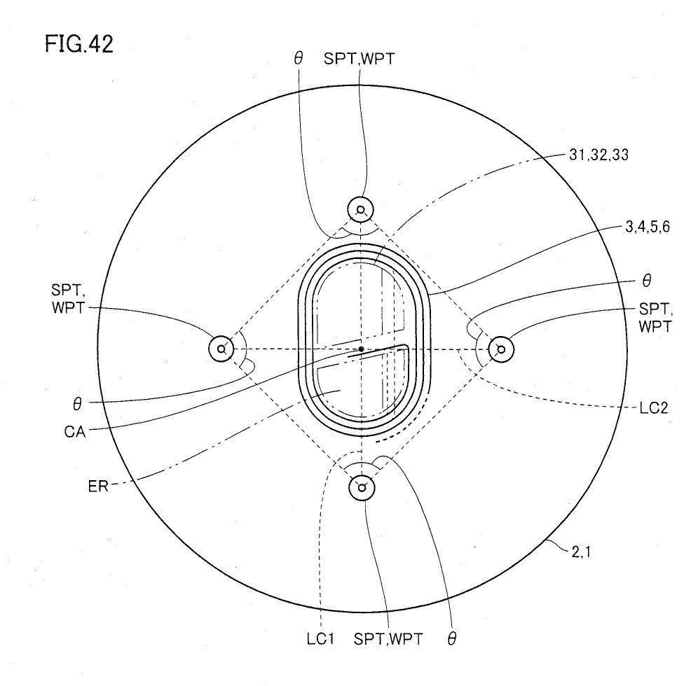

In an electrolytic capacitor manufactured with the use of a core, the core is removed after an anode foil, a cathode foil, and the like are wound up. Therefore, in a central portion of a capacitor element, a region reflecting the outer shape of the core can be observed. FIG. 42 shows such a state that anode foil 3, cathode foil 4, and separator paper 5, 6 are wound up in a layered state. The region reflecting the outer shape of the core is present as such an enclosed region ER that a region shown with a double chain dotted line corresponding to core 31, 32, 33 (the B type, the C type, the D type) is enclosed by anode foil 3, cathode foil 4, and the like.

Since this enclosed region ER reflects the outer shape of the removed core, the outer shape thereof has a long-side direction and a short-side direction in a cross-section perpendicular to the central axis of the capacitor element (rotation central axis CA of the core), and with a straight line in the long-side direction passing through the central axis (rotation central axis CA) being defined as first centerline LC1 and with a straight line in the short-side direction passing through the central axis being defined as second centerline LC2, enclosed region ER exhibits a shape asymmetric with respect to second centerline LC2 in the long-side direction (first asymmetry) and/or a shape asymmetric with respect to first centerline LC1 in the short-side direction (second asymmetry).

With respect to such an enclosed region ER, the first anode lead tab terminal and the first cathode lead tab terminal (both-side pressed terminal WPT, one-side pressed terminal SPT) are arranged in one of the long-side direction and the short-side direction thereof, and the second anode lead tab terminal and the second cathode lead tab terminal (both-side pressed terminal WPT, one-side pressed terminal SPT) are arranged in the other of the long-side direction and the short-side direction thereof. Angle θ of each of vertices of a quadrangle formed by connecting leads 12 of the first anode lead tab terminal, the first cathode lead tab terminal, the second anode lead tab terminal, and the second cathode lead tab terminal (see FIGS. 1, 29A, and 29B) is 90°±20° (from 70° to 110°). It is noted that a structure including such an enclosed region in the electrolytic capacitor can be observed, for example, with a CT-X-ray apparatus.

### Examples

The inventors fabricated 300 electrolytic capacitors by applying a both-side pressed terminal as the first (second) anode lead tab terminal, for each of core 31 (the B type), core 32 (the C type), and core 33 (the D type), with the method described in the first embodiment, and evaluated attachment of the sealing rubber gasket. In addition, the inventors fabricated 300 electrolytic capacitors by using core 130 (the A type) as the comparative example and similarly evaluated attachment of the sealing rubber gasket. Table 1 shows results.

TABLE 1

| | | The Number of |
|---|---|---|
| | Core Type | Defects Caused |
| Inventive Example 1 | B type | 3/300 p |
| Inventive Example 2 | C type | 3/300 p |
| Inventive Example 3 | D type | 0/300 p |
| Comparative Example | A type | 33/300 p |

As shown in Table 1, it was demonstrated that, among the electrolytic capacitors according to the comparative example, defective attachment was found in 33 of 300 electrolytic capacitors, whereas the number of defects caused was 3 in the electrolytic capacitors fabricated by using the core (the B type) and the core (the C type), and that the number of defects caused could significantly be reduced. In addition, with regard to the core (the D type), the number of defects caused was 0 and the best result was obtained.

Based on this evaluation result, it was demonstrated that, by winding up an anode foil, a cathode foil, and the like around a (geometrically) asymmetric core, positions of the leads of the first (second) anode (cathode) lead tab terminals could be brought closer to positions corresponding to respective vertices of a square, so that registration with a sealing rubber gasket, a seat plate, and the like is facilitated to improve productivity and to contribute to lowering in ESL.

It is noted that a thickness of each of anode foil 3, cathode foil 4, and separator paper 5, 6, a manner of layering thereof, and a size of each portion of core 31, 32, 33 explained in each embodiment described above are by way of example and they are not limited as such, and an optimal condition is selected depending on a type, a size, a material, or the like of an electrolytic capacitor.

### INDUSTRIAL APPLICABILITY

The present invention is effectively utilized in a wound-type electrolytic capacitor formed by winding up an anode (cathode) foil from a one-end side.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of manufacturing an electrolytic capacitor of a wound type, comprising the steps of:
preparing an anode foil and a cathode foil;
preparing a prescribed core for winding up said anode foil and said cathode foil;
preparing a first anode lead tab terminal, a second anode lead tab terminal, a first cathode lead tab terminal, and a second cathode lead tab terminal;
connecting said first anode lead tab terminal and said second anode lead tab terminal at respective prescribed positions in said anode foil;
connecting said first cathode lead tab terminal and said second cathode lead tab terminal at respective prescribed positions in said cathode foil;
forming a capacitor element by sandwiching respective one-end sides of said anode foil and said cathode foil in said core, turning said core around a rotation central axis thereof, and winding up said anode foil and said cathode foil from said respective one-end sides, with said first anode lead tab terminal, said second anode lead tab terminal, said first cathode lead tab terminal, and said second cathode lead tab terminal being arranged in any of prescribed first arrangement and second arrangement with respect to said core;
attaching a sealing member to said capacitor element; and
accommodating said capacitor element to which said sealing member has been attached in a prescribed container and sealing said capacitor element,
in said step of preparing a core, such a core as exhibiting an outer shape having a long-side direction and a short-side direction in a cross-section perpendicular to said rotation central axis being prepared, with a straight line in said long-side direction passing through said rotation central axis being defined as a first centerline and with a straight line in said short-side direction passing through said rotation central axis being defined as a second centerline, said outer shape being in asymmetry in a manner at least any of first asymmetry which is asymmetry with respect to said second centerline in said long-side direction and second asymmetry which is asymmetry with respect to said first centerline in said short-side direction, and
in said step of forming a capacitor element,
said first arrangement being such arrangement that, with respect to said core, said first anode lead tab terminal is arranged on one side in said long-side direction, said first cathode lead tab terminal is arranged on the other side in said long-side direction, said second anode lead tab terminal is arranged on one side in said short-side direction, and said second cathode lead tab terminal is arranged on the other side in said short-side direction, and
said second arrangement being such arrangement that, with respect to said core, said second anode lead tab terminal is arranged on one side in said long-side direction, said second cathode lead tab terminal is arranged on the other side in said long-side direction, said first anode lead tab terminal is arranged on one side in said short-side direction, and said first cathode lead tab terminal is arranged on the other side in said short-side direction.

2. The method of manufacturing an electrolytic capacitor according to claim 1, wherein
in said step of preparing a first anode lead tab terminal, a second anode lead tab terminal, a first cathode lead tab terminal, and a second cathode lead tab terminal, each of said first anode lead tab terminal, said second anode lead tab terminal, said first cathode lead tab terminal, and said second cathode lead tab terminal includes
a connection portion connected to corresponding said anode foil or said cathode foil, and
a lead electrically connected to said connection portion and serving as a terminal having corresponding polarity,
said connection portion and said lead are of a type formed such that a position in a radial direction of said lead is coincident with a position in a radial direction of said connection portion while said capacitor element is formed, and
in said step of forming a capacitor element, said first arrangement is adopted.

3. The method of manufacturing an electrolytic capacitor according to claim 1, wherein
in said step of preparing a first anode lead tab terminal, a second anode lead tab terminal, a first cathode lead tab terminal, and a second cathode lead tab terminal, each of said first anode lead tab terminal, said second anode lead tab terminal, said first cathode lead tab terminal, and said second cathode lead tab terminal includes
a connection portion connected to corresponding said anode foil or said cathode foil, and
a lead electrically connected to said connection portion and serving as a terminal having corresponding polarity, and
said connection portion and said lead include
a first type formed such that a position in a radial direction of said lead is coincident with a position in a radial direction of said connection portion while said capacitor element is formed, and
a second type formed such that a position in a radial direction of said lead is different from a position in a radial direction of said connection portion while said capacitor element is formed,
one of said first anode lead tab terminal and said second anode lead tab terminal is of said first type and the other thereof is of said second type, and
one of said first cathode lead tab terminal and said second cathode lead tab terminal is of said first type and the other thereof is of said second type.

4. The method of manufacturing an electrolytic capacitor according to claim 3, wherein
in said step of forming a capacitor element, said first arrangement is adopted,
said first anode lead tab terminal and said first cathode lead tab terminal are of said first type,
said second anode lead tab terminal and said second cathode lead tab terminal are of said second type, and
said second anode lead tab terminal and said second cathode lead tab terminal are arranged such that corresponding said leads are shifted radially inward.

5. The method of manufacturing an electrolytic capacitor according to claim 3, wherein
in said step of forming a capacitor element, said first arrangement is adopted,
said first anode lead tab terminal and said first cathode lead tab terminal are of said second type,
said second anode lead tab terminal and said second cathode lead tab terminal are of said first type, and
said first anode lead tab terminal and said first cathode lead tab terminal are arranged such that said leads are shifted radially outward.

6. The method of manufacturing an electrolytic capacitor according to claim 3, wherein
in said step of forming a capacitor element, said second arrangement is adopted,
said first anode lead tab terminal and said first cathode lead tab terminal are of said second type,
said second anode lead tab terminal and said second cathode lead tab terminal are of said first type, and
said first anode lead tab terminal and said first cathode lead tab terminal are arranged such that said leads are shifted radially outward.

7. The method of manufacturing an electrolytic capacitor according to claim 3, wherein
in said step of forming a capacitor element, said second arrangement is adopted,
said first anode lead tab terminal and said first cathode lead tab terminal are of said first type,
said second anode lead tab terminal and said second cathode lead tab terminal are of said second type, and
said second anode lead tab terminal and said second cathode lead tab terminal are arranged such that said leads are shifted radially inward.

8. The method of manufacturing an electrolytic capacitor according to claim 1, wherein
in said step of preparing a first anode lead tab terminal, a second anode lead tab terminal, a first cathode lead tab terminal, and a second cathode lead tab terminal, each of said first anode lead tab terminal, said second anode lead tab terminal, said first cathode lead tab terminal, and said second cathode lead tab terminal includes
a connection portion connected to corresponding said anode foil or said cathode foil, and
a lead electrically connected to said connection portion and serving as a terminal having corresponding polarity, and
said connection portion and said lead are of a type formed such that a position in a radial direction of said lead is different from a position in a radial direction of said connection portion while said capacitor element is formed.

9. The method of manufacturing an electrolytic capacitor according to claim 8, wherein
in said step of forming a capacitor element, said first arrangement is adopted, and
said first anode lead tab terminal and said first cathode lead tab terminal are arranged such that said leads are shifted radially outward, and said second anode lead tab terminal and said second cathode lead tab terminal are arranged such that said leads are shifted radially inward.

10. The method of manufacturing an electrolytic capacitor according to claim 8, wherein
in said step of forming a capacitor element, said second arrangement is adopted, and
said first anode lead tab terminal and said first cathode lead tab terminal are arranged such that said leads are shifted radially outward, and said second anode lead tab terminal and said second cathode lead tab terminal are arranged such that said leads are shifted radially inward.

11. An electrolytic capacitor formed by winding band-shaped anode foil and cathode foil, comprising a capacitor element which includes
an anode foil and a cathode foil wound up in a prescribed orientation from one-end side, in a manner opposed to each other,
a first anode lead tab terminal and a second anode lead tab terminal arranged at respective prescribed positions in said anode foil, and
a first cathode lead tab terminal and a second cathode lead tab terminal arranged at respective prescribed positions in said cathode foil,
in a central portion of said capacitor element, an enclosed region enclosed by said anode foil and said cathode foil wound up from said one-end side being located,
said enclosed region having an outer shape having a long-side direction and a short-side direction in a cross-section perpendicular to a central axis of said capacitor element,
with a straight line in said long-side direction passing through said central axis being defined as a first centerline and with a straight line in said short-side direction passing through said central axis being defined as a second centerline, said outer shape exhibiting an asymmetrical shape in a manner at least any of first asymmetry which is asymmetry with respect to said second centerline in said long-side direction and second asymmetry which is asymmetry with respect to said first centerline in said short-side direction,
said first anode lead tab terminal and said first cathode lead tab terminal being arranged in one of said long-side direction and said short-side direction with respect to said enclosed region, and
said second anode lead tab terminal and said second cathode lead tab terminal being arranged in the other of said long-side direction and said short-side direction with respect to said enclosed region.

12. The electrolytic capacitor according to claim 11, wherein
a two-dimensional pattern of arrangement of an anode lead of said first anode lead tab terminal, an anode lead of said second anode lead tab terminal, a cathode lead of said first cathode lead tab terminal, and a cathode lead of said second cathode lead tab terminal is such a pattern that the leads are arranged at positions corresponding to respective vertices of a quadrangle, and
an angle formed by a vertex of said quadrangle is from 70 to 110°.
